(19) United States
(12) Patent Application Publication
(10) Pub. No.: US 2006/0293928 A1
(43) Pub. Date: Dec. 28, 2006

(54) Method and system to recommend insurance plans

(76) Inventors: Eric Schumacher, Milpitas, CA (US); Jeffery Hutchings, Rancho Cordova, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/168,235

(22) Filed: Jun. 27, 2005

(51) Int. Cl. G06Q 40/00; G07G 1/00

(52) U.S. Cl. 705/4; 705/10

(57) ABSTRACT

A system and method are provided to recommend at least one insurance plan (e.g., a health insurance plan) to a user via a computer network. In an embodiment, the method includes presenting at least one question to a user via a client device. The question may be for identification of at least one insurance plan and an answer to the question. A database may be investigated to identify a subsequent question associated with the answer provided to the first question by the user, wherein the subsequent question also being for identification of the at least one insurance plan. Thereafter, the subsequent question is presented to the user and a subsequent answer to the subsequent question is then received. Investigating the database to identify a subsequent question and receiving the subsequent answer is iteratively performed in a dynamic and interactive way to identify the at least one insurance plan.

### TECHNICAL FIELD

The present application relates generally to the technical field of a network-based recommendation tool. For example, an example embodiment relates to recommending health insurance plans to a user via a computer network.

### BACKGROUND

Websites now enable users to obtain insurance (e.g. health insurance) online via the Internet. However, such websites typically present users simultaneously (e.g., via a single display screen) with a vast number of questions to respond to and, many of the questions may not even be relevant to the specific user's personal circumstances. Often times the user does not understand the insurance industry and, accordingly, some of the questions may in fact be meaningless to the user. Thus, a user is not guided in any way in order to assist the user in identifying an insurance plan suitable to the specific needs of the user.

Thus, despite the many advantages the Internet offers, in certain industries it is a challenge to interact with a user via the Internet and to limit such interactions only to relevant issues. This challenge is particularly prevalent in the complex health insurance industry. This complexity is due, in part, to how heavily regulated the health insurance industry is. Health insurance providers, such as the health insurance carriers, who underwrite and issue health insurance policies, and the brokers or agents who sell those policies or plans (plan providers), must strictly comply with federal laws that regulate security, privacy and personal medical information (e.g., comply with The Health Insurance Portability and Accountability Act of 1996; Gramm-Leach Bliley Act of 1999, and so on). As a result of the aforementioned, health insurance plans are not only user/applicant specific but also geographical location specific. Further, it will be appreciated that the information required from a user in order to ascertain which insurance plan is appropriate for the user may differ from applicant to applicant. Thus, by presenting a user simultaneously with a plurality of questions, many of the questions may not be relevant at all to a particular insurer and/or insurance plan.

### SUMMARY

According to one example embodiment, there is provided a system and a method to recommend at least one insurance plan (e.g., a health insurance plan) to a user via a computer network. In an embodiment, the method includes:
presenting at least one question to a user via a client device, the question being for identification of the at least one insurance plan;
receiving an answer to the question from the client device;
investigating a database to identify a subsequent question associated with the answer provided to the first question by the user, the subsequent question also being for identification of the at least one insurance plan;
presenting the subsequent question to the user; and
receiving a subsequent answer to the subsequent question, wherein the investigating the database to identify a subsequent question and receiving the subsequent answer is iteratively performed to identify the at least one insurance plan.

The invention extends to a machine-readable medium including instructions for performing any one or more of the methodologies described herein.

Other features will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, and in which like references indicate the same or similar elements.

In the drawings,

FIG. 1 shows a schematic architectural overview of an example embodiment of a network-based system for recommending a health insurance plan;

FIG. 2 shows exemplary functional modules of a recommendation tool or application of the system of FIG. 1;

FIG. 3 shows an example functional diagram illustrating a filtering method to identify a limited number of appropriate health insurance plans for a user;

FIG. 4 shows example communications between a recommendation tool and a user of the tool illustrating a dynamic and interactive nature of communications;

FIG. 5 shows an example of question and answer mapping during the dynamic and interactive communications between a user and the recommendation tool;

FIG. 6 shows a schematic block diagram of an example method of deploying the recommendation tool in a web-based environment;

FIG. 7 shows a flow diagram of a method of recommending a limited number of health care insurance plans to a user;

FIG. 8 shows an example graphical user interface of a “Quote” page providing a user with an option to select the recommendation tool;

FIG. 9 shows an example graphical user interface of a “Quote” page displaying recommendations;

FIG. 10 shows an example graphical user interface of a “Details” page providing a user with an option to select the recommendation tool;

FIG. 11 shows an example graphical user interface of a “Details” page displaying recommendations;

FIG. 12 shows an example graphical user interface providing a question and possible answers to the questions, and educational information presented to the user;

FIG. 13 shows an example graphical user interface that allows a user to view recommendations made by the recommendation tool;

FIG. 14 shows an example graphical user interface that presents a plurality of available plans arranged in cost ranges;

FIG. 15 shows a more detailed schematic flow diagram of a method, in accordance with an example embodiment, of recommending a limited number of health insurance plans to a user via the Internet;

FIG. 16 shows a schematic flow diagram of a method, in accordance with an example embodiment, to present product line vectoring questions to a user;

FIG. 17 shows a schematic flow diagram of a method, in accordance with an example embodiment, of presenting medical vectoring questions to a user;

FIG. 18 shows a schematic flow diagram of a method, in accordance with an example embodiment, of presenting plan benefit questions to a user;

FIG. 19 shows a diagrammatic representation of a machine in the example form of a computer system for performing any one or more of the methodologies described herein; and

FIGS. 20-37 show example questions, answers and educational information that may be selectively presented to the user.

### DETAILED DESCRIPTION

A method and system to recommend at least one insurance plan (e.g., a health insurance plan) are described. In the following description, for purposes of explanation, numerous specific details are set forth in order to provide a thorough understanding of example embodiments of the present invention. It will be evident, however, to one skilled in the art that the present invention may be practiced without these specific details.

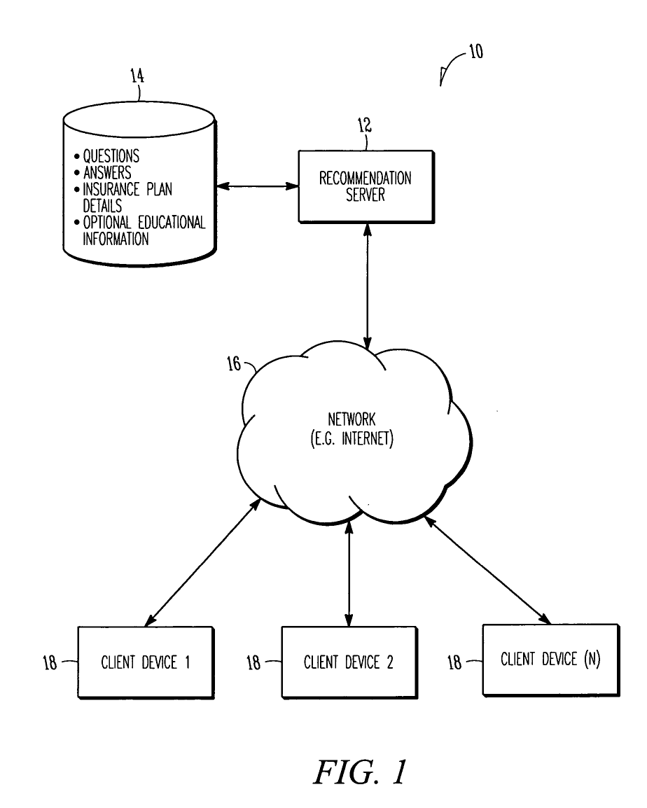

Referring to FIG. 1, reference 10 generally shows a schematic architectural overview of an example embodiment of a network-based system for recommending a health insurance plan to a user. The network-based system 10 is shown to include a recommendation server 12 with an associated database 14 including a plurality of questions, answers, and insurance plan data to provide health insurance plan recommendation(s) to the user in a dynamic and interactive way. Accordingly, the recommendation server 12 communicates via one or more networks, such as the Internet 16, with a plurality of client devices 18. The client devices 18 may, for example, include a personal computer (PC), a Personal Digital Assistant (PDA), a cellular telephone, or any other client device. The client devices 18 may be connected wirelessly and/or in a wired fashion with the recommendation server 12 via the Internet 16. As described in more detail below, the user or applicant (e.g. a person investigating or seeking a health insurance plan) may interact with the recommendation server 12 in order to obtain a recommendation of one or more health insurance plans relevant to the user's needs.

In order to avoid presenting the user with a multitude of different health insurance plans, some of which may not be relevant, the recommendation server 12 (e.g., running a recommendation tool or application) filters a total number of health insurance plans potentially available to a user down to a limited number or preselected number (e.g. one to four health insurance plans) which are then presented to the user. Accordingly, in an example embodiment, only the most relevant and appropriate health insurance plans are identified and recommended to the user, and less appropriate (or inappropriate) health insurance plans are not presented to the user. An interactive and dynamic process may be performed by the recommendation tool or application on the recommendation server 12 to narrow down a multitude of health insurance plans to identify only a small number of appropriate health insurance plans. The appropriateness of a health insurance plan may depend, inter alia, on a geographical location of the user, data related to the health insurance plans available, medical data associated with a user, plan benefit requirements, the likelihood of an insurer/carrier of approving the user based on the information provided by the user, or the like. In an example embodiment, educational information (e.g., which stored in the database 14) is optionally provided or presented to the user by the recommendation server 12. As interaction with the user is done in a dynamic and interactive fashion, in an example embodiment, a user may be guided through a filtering process that sequentially narrows down a number of potentially relevant health insurance plans to a limited number of appropriate health insurance plans thus, for example, facilitating the selection process by the user.

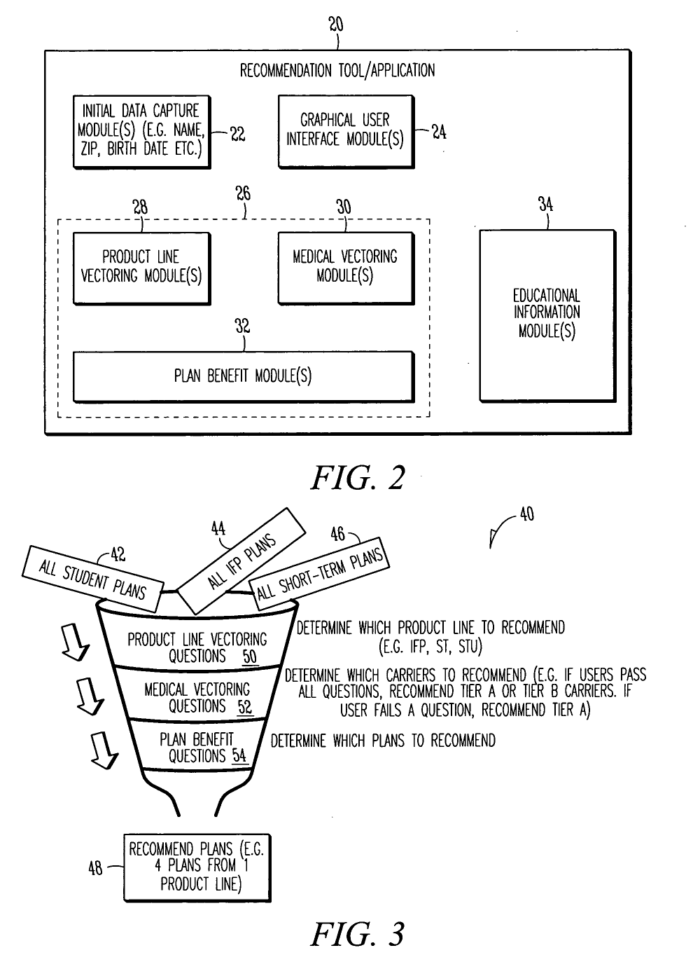

FIG. 2 shows example functional modules of a recommendation tool or application 20 which, for example, may be provided at the recommendation server 12. The recommendation tool 20 is shown to include an initial data capture module 22, a graphical user interface (GUI) module 24, and a filtering module 26 which may filter out a limited number (e.g. 1-4) of health insurance plans from a plurality of available health insurance plans. The filtering may take place via a series of appropriate questions presented to the user and the answers provided by the users. The filtering module 26 may comprise a product line vectoring module 28, a medical vectoring module 30, and a plan benefit module 32.

The product line vectoring module 28 may control or determine the presentation or display of a plurality of questions in order to determine a particular product line (e.g., health insurance product line) to recommend to the user. Examples of such product lines include an Individual and Family Plan (IFP), a Short-Term Insurance Plan (ST), and a Student Insurance Plan (STU). As described in more detail below, in an embodiment, a sequence of questions is presented to the user wherein a next or subsequent question is dependent upon an answer to a previous question. Accordingly, only appropriate questions relevant to an appropriate product line are presented to the user. Likewise, the medical vectoring module 30 may present a sequence of questions to the user wherein a subsequent question is dependent upon an answer to a previous question. In response to answers to the questions, the recommendation tool 20 may identify or recommend a predetermined number of health insurance carriers (health insurance providers) that are appropriate for the particular user.

In an example embodiment, possible health insurance carriers available to the user may be arranged into two or more categories or groups (e.g., tier A IFP (individual and family) carriers and tier B IFP carriers) wherein health insurance carriers within a selected group are more appropriate for the user. For example, the health insurance carriers in the group may be more likely to approve an application for health insurance by the user.

The plan benefit module 32 may also present a series of questions in a sequential manner wherein an answer to a previous question may be used to determine a subsequent question so that only relevant questions are posed or communicated to the user. In an example embodiment, relevant educational information may be presented or displayed that accompanies a question presented to the user. The educational information may provide further information relating to the question and/or assist or guide the user in choosing an answer to the question.

In an example embodiment, the initial data capture module 22 captures a zip code to identify a geographical location, a birth date, or the like. This may constitute a first step in a filtering process to determine a number of potential health insurance plans available to the user. Thereafter, the product line vectoring module 28 identifies possibly relevant product lines, followed by the medical vectoring module 30 identifying or filtering out only those product lines that may be relevant based on the medical vectoring questions. The plan benefit modules 32 then further filters the remaining health insurance plans to identify any one or more health insurance plans suitable for recommendation to the user. FIG. 3 shows an example functional diagram illustrating a filtering method 40 to identify appropriate health insurance plans for a user. The method is shown by way of example to filter all student plans 42, all IFP plans 44, and all short-term plans 46 available to a specific user to provide one to four recommended plans 48. In the method 40, product line vectoring questions 50 are first asked to reduce the number of available plans, thereafter, medical vectoring questions 52 are asked further to reduce the number of available plans and, finally, plan benefit questions 54 are then asked to distil out or filter out a limited number of recommended plans 48. It will, however, be appreciated that the medical vectoring questions 52 may be asked before the product line vectoring questions 50; the plan benefit questions 54 may be asked before the medical vectoring questions 52; and so on. However, the sequence of asking the questions shown in the method 40 (product line vectoring questions 50, followed by medical vectoring questions 52, followed by plan benefit questions 54) may, in circumstances, render the method 40 more efficient.

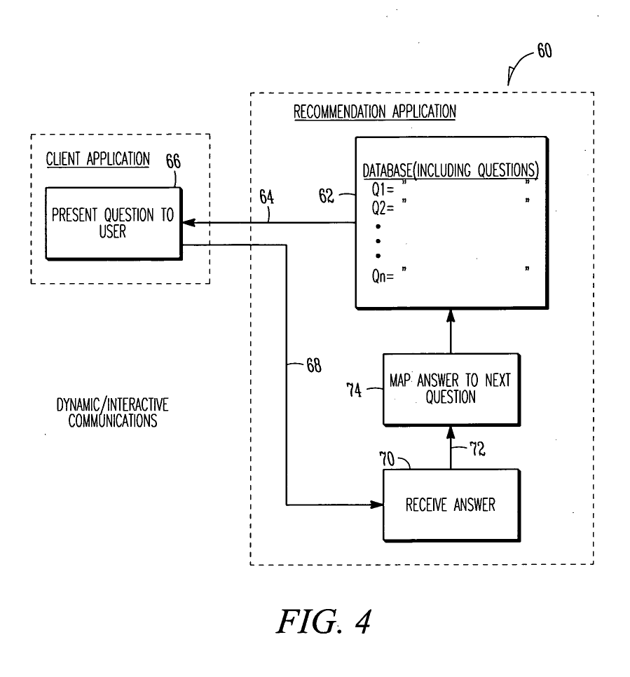

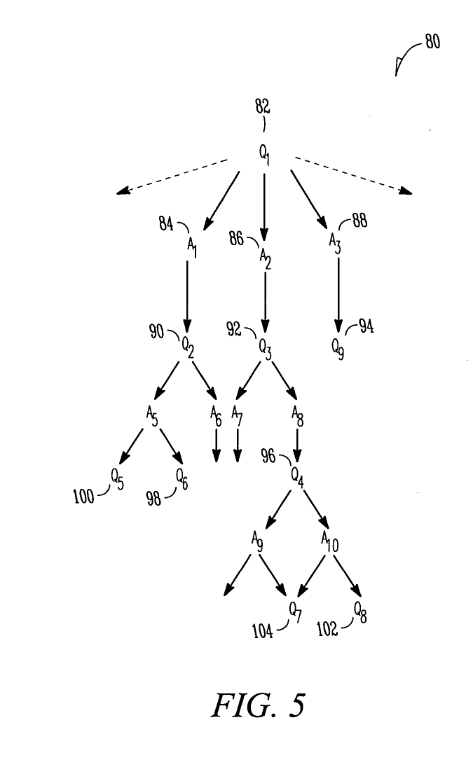

FIG. 4 shows example communications 60 between a recommendation tool or application (e.g. the recommendation tool 20) and a user illustrating the dynamic and interactive nature of the communications. As shown at functional block 62, a database of questions may be provided that are used to guide or navigate the user through a selection process to narrow down a multitude of potentially available health insurance plans to a more meaningful and appropriate selected number of health insurance plans. During execution of the method 60, relevant questions are communicated (see arrow 64) to the user as shown at functional block 66. The question may also include a number of possible answers which a user may then select, and the selection is then communicated back to the recommendation application as shown by arrow 68. Upon receipt of the answer (see functional block 70), the answer is communicated to functional block 74 where the answer is mapped to the next question to be presented to the user. Accordingly, in the method 60 the user is guided through a selection process and only relevant questions are posed to the user. FIG. 5 shows an example of question and answer mapping 80 that may take place during the dynamic and interactive communications shown, by way of example, in FIG. 4. In the mapping 80, an initial question 82 may be asked to narrow down a number of health insurance plans available to the user. For example, the initial question 82 may request the user to enter a zip code of a geographical area or location of interest. Thus, answers 84-88 may correspond to different zip codes and, depending on the particular answer or zip code, one of the questions 90-94 may then be presented to the user. Thus, as shown by the mapping 80, only questions relevant to the particular user are presented to the user. In the example mapping 80 shown in FIG. 5, questions 90-94 may be the product line vectoring questions 50, questions 96-100 may be the medical vectoring questions 52, and questions 102, 104 may be the plan benefit questions 54. It will thus be appreciated that the recommendation tool or application communicates with a user in a dynamic and interactive fashion where a user may be led along a path or sequence of questions where only relevant questions are presented to the user. At any point during the process, a name of one or more persons requiring health insurance coverage may be requested.

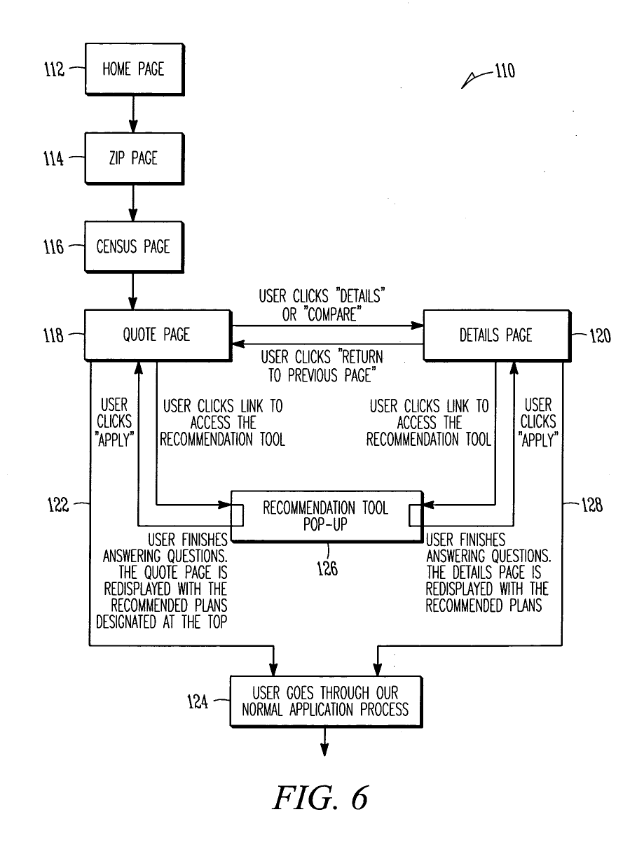

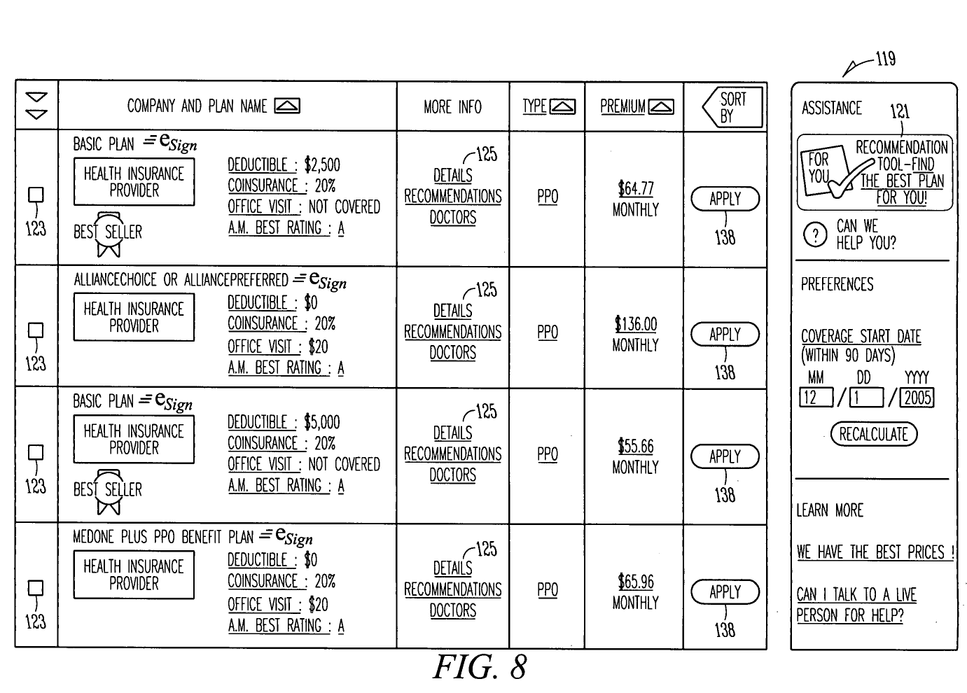

FIG. 6 shows a schematic block diagram of an example method 110 of deploying the recommendation tool in a web-based environment. As shown at block 112, when a user goes to a uniform resource locator (URL) associated a health insurance web site, a home page may be presented to the user. It will be appreciated that the web page may provide many different types of functionality associated with health insurance plans. Initially, a graphical user interface is presented to the user requesting a zip code to identify a geographical area or location in which the user seeks to obtain health insurance (see block 114). As health insurance plans are location specific, this information may identify only those health insurance plans that the user may be eligible for. Thereafter, as shown at block 116, census page may be displayed to obtain census data of the user. Typically, such census data includes depending on whether a user is seeking health insurance for only himself/herself or for others as well: a date of birth of the user or applicant, the date of birth of a spouse, a date of birth of one or more children, whether or not the user has used tobacco in the last 12 months, whether or not the user is a full time college student, a date on which the user would like to commence health insurance coverage, or other initial potentially relevant information. In an example embodiment, a “Quote” page 119 (see block 118 and FIG. 8) is then presented to the user listing some or all available plans in the geographical area available to the user. It will be appreciated that a large number (e.g. in excess of 100 plans) may be available to the user and, accordingly, the user may then be presented with an option to use the recommendation tool (see recommendation button 121 in FIG. 8) to narrow down the number of available plans to a fewer number of more appropriate plans.

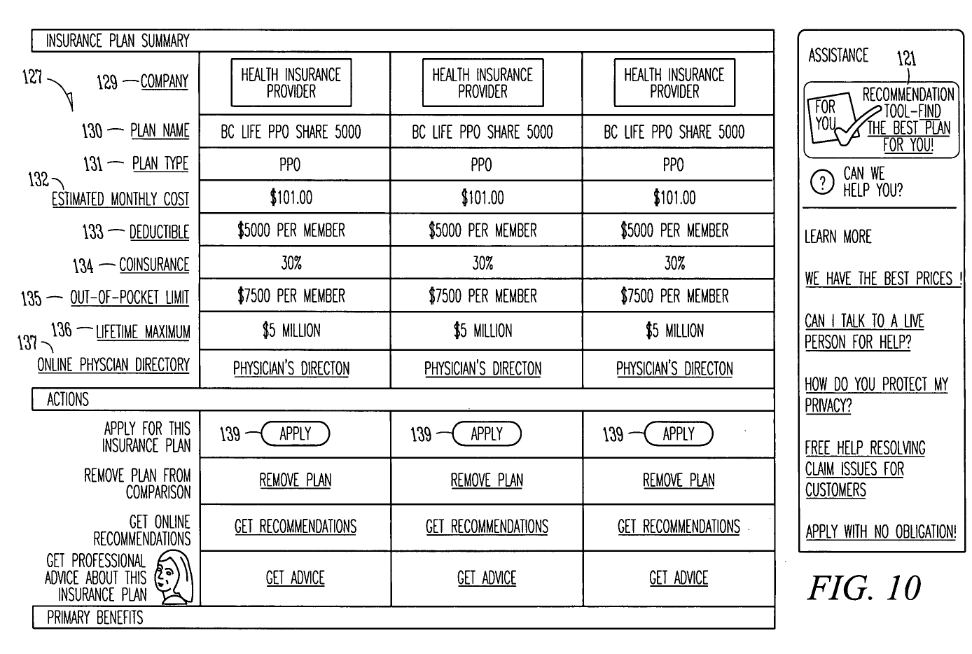

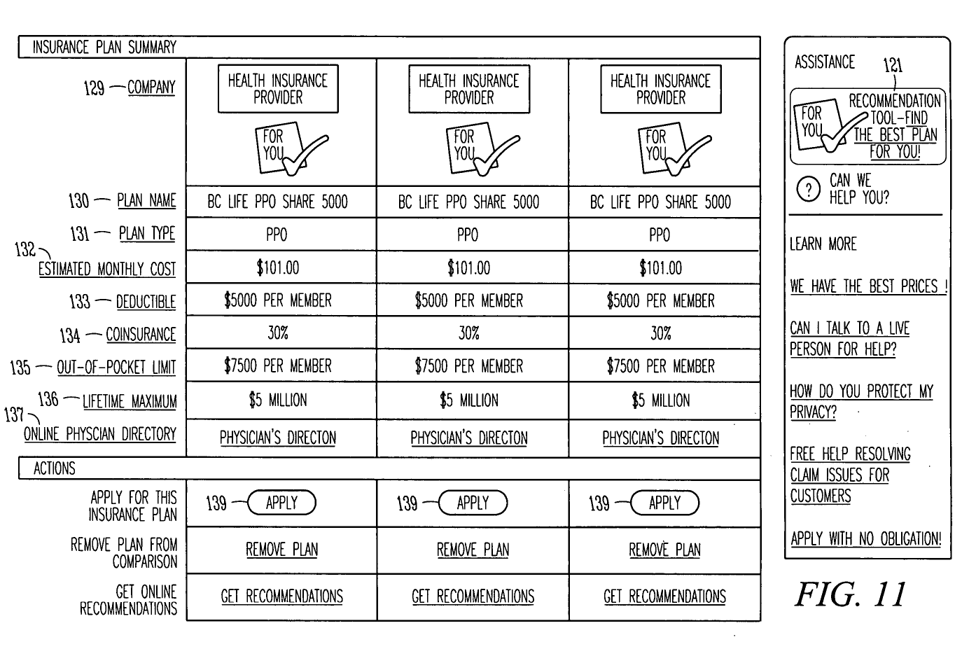

From the Quote page 119 (see FIG. 8), a user may compare selected health insurance plans by checking two or more checkboxes 123, and may view details on each health insurance plan (see “Details” buttons 125). To this end, a “Details” page 127 (see block 120 and FIG. 10) is provided. The Details page 127 may provide details of benefits provided by a selected health insurance plan. For example, the Details page 127 may display a health care provider name 129, a plan name 130, a plan type 131, an estimated monthly cost 132, a deductible 133, coinsurance 134, an out-of-pocket limit 135, a lifetime maximum 136, an online physician directory 137, and so on. Further, a user may select any one of the multitude of plans presented to the user and make the application on line as shown by arrows 122 and 128 (see FIG. 6).

If the user identifies an appropriate health insurance plan, by clicking on an “Apply” button 138 (see FIG. 8) or 139 (see FIG. 10), the user may then go through a normal application process (see block 124 in FIG. 6) which, in an embodiment, may be an automated process. Dependent upon an outcome of the application process the user may or may not be enrolled in the health insurance plan selected.

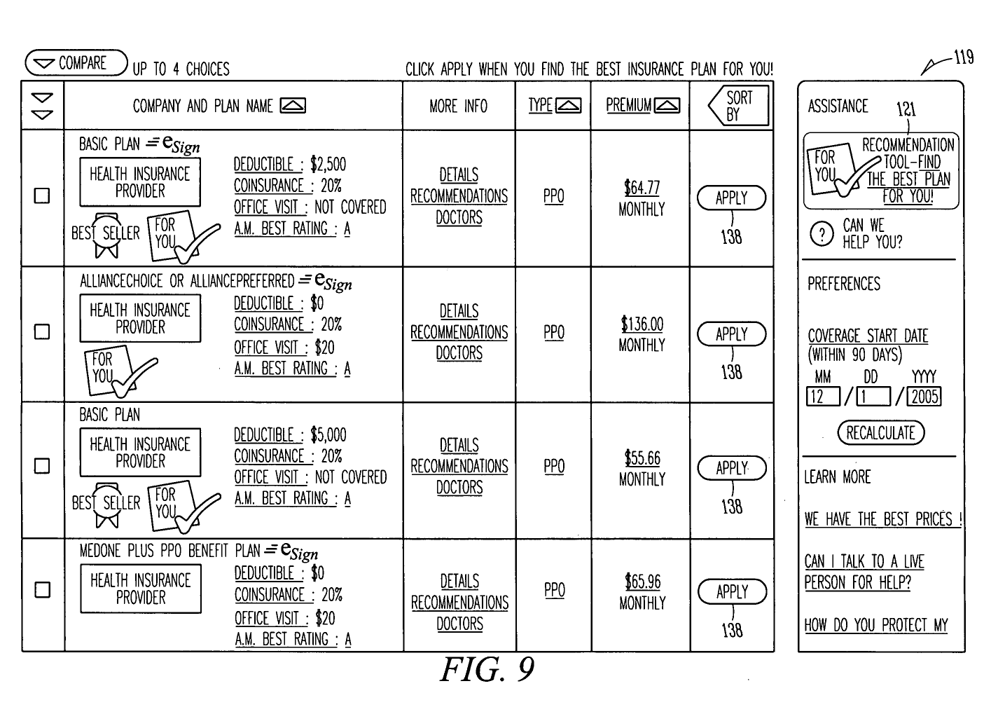

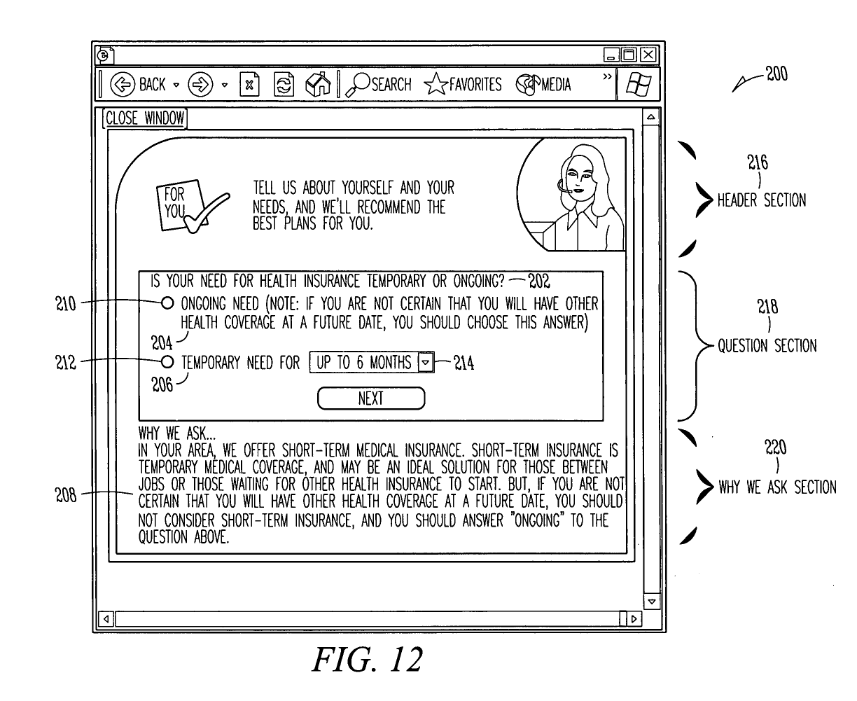

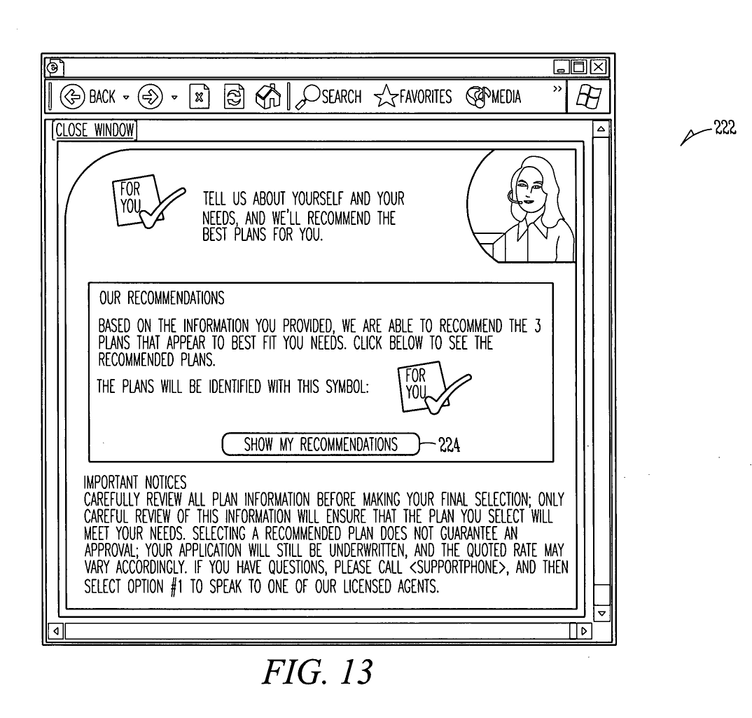

However, in order to assist a user in selecting an appropriate health insurance plan, the user may click on the recommendation tool button 121 whereupon the user is guided during a dynamic and interactive process in selecting or identifying a limited number of more appropriate health insurance plans. In an embodiment, a recommendation tool pop-up (see block 126) is provided to the user. The recommendation tool pop-up may include a plurality of different graphical user interfaces (two of which are shown by way of example in FIGS. 12 and 13). As described above with reference to FIGS. 4 and 5, a plurality of questions may then be presented to the user. If the recommendation tool 20 has been accessed from the Quote page 119 (see FIG. 8) then, upon completion of a sequence of questions presented to the user, the Quote page 119 may then be redisplayed (see FIG. 9) showing the recommended plans. Likewise, if the recommendation tool 20 has been accessed from the Details page 127 (see FIG. 10) then, upon completion of the sequence of questions presented to the user, the Details page 127 may then be redisplayed showing the recommended health insurance plans. As described above with reference to the Quote page 119, the Details page 127 may also allow a user to select a particular health insurance plan either directly or based on a recommendation, and apply for enrollment within the plan (see arrow 128).

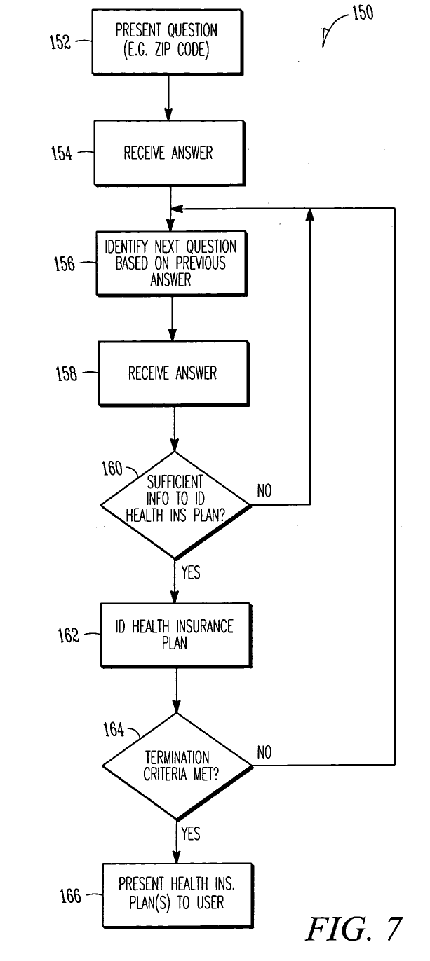

FIG. 7 shows a flow diagram of a method 150 recommending a limited number of health insurance plans to a user. The method 150 may be performed by the method 110 in a web-based deployment of the recommendation tool 20. As shown at block 152, the method 150 may present an initial question to the user (e.g. a zip code of the user) to identify all possible health insurance plans available to the user for the given geographical location (e.g. a state in the USA). Thereafter, as shown at block 154, the method 150 receives the answer (a zip code in the given example) and, as shown at block 156, the method 150 then identifies the next or subsequent question that should be presented to the user based on the previous answer given by the user. Thereafter, an answer to the subsequent question is received at 158 and, as shown at decision block 160, the method 150 then determines whether or not sufficient information has been provided or obtained so as to recommend a limited number of health insurance plans to the user. If not, the method 150 returns to block 156 and presents a further question to the user, receives a further answer 158 and thus, in a sequential fashion, may drill down through a list of relevant questions to identify a limited number of appropriate health insurance plans.

Returning to decision block 160, if sufficient information has been obtained to identify one or more health insurance plans then, as shown at block 162, the information received from the user is processed to identify a particular health insurance plan that may be available to the user. Thereafter, as shown at decision block 164, the method 150 determines if determination criteria have been met. For example, the determination criteria may include a minimum number of health insurance plans that are to be recommended to the user. Accordingly, if only one health insurance plan has been identified, the method 150 may then return to block 156 to obtain further details from the user so as to enable the method 150 to identify further health insurance plans. Once a pre-determined number (e.g. four health insurance plans) have been identified, the method 150 may then present the four health insurance plans to the user as shown at block 166. As the method 150 may be a software application, a database comprising a substantial number of questions may be created wherein each question is associated with one or more answers that are presented to the user. Upon selection of one of the provided answers, a further question may then be presented to the user. Accordingly, as herein before described, a mapping of answers to questions may be provided and the user may be led through a selection process in an automated fashion and in a dynamic and interactive way.

FIG. 12 shows an example graphical user interface 200 providing a question 202 and possible answers 204 and 206 to the question 202, and educational information 208 that may be presented to the user. In the example interface 200, a user may click a checkbox 210, 212 corresponding to an appropriate answer. A dropdown menu 214 is provided to allow a user to select a duration of temporary insurance. In a similar fashion a plurality of other questions may be selected from further graphical user interfaces. Each graphical user interface may include a “Header Section” 216, a “Question Section” 218, and a “Why We Ask Section” 220. FIG. 13 shows an example graphical user interface 222 that allows a user to view recommendations made by the recommendation tool 20. In order to view the recommendations, a user may click on the “Show My Recommendations” button 224. In response thereto, a graphical user interface 224 may be provided that presents a plurality of available plans arranged in cost ranges. For example, cost ranges 226-232 which are associated with corresponding plans 234-240. It will be noted in the example embodiment that a number of plans available in each cost range 226-232 is shown as well as the average cost per month for the plans. Thus, the method 150 may determine a plurality of monetary ranges and identify a plurality of insurance plans in each monetary range. Thereafter a graphical user interface displaying the monetary ranges and the a number of insurance plans in each range may be communicated to each user. Selection of one of the plurality of ranges by the user may be monitored details of each plan within a selected range may then be communicated to the user.

The graphical user interface 224 may provide a cost-benefit analysis to a user. In certain circumstances users may select many benefits when seeking health insurance without any appreciation of the cost implications. The recommendation tool 20 may allow the user to see the cost of each benefit before choosing or selecting a benefit. In an example, when a user selects one of the cost ranges 226-232, benefits associated with each plan are displayed so that the user can view a trade-off as he or she goes down in price.

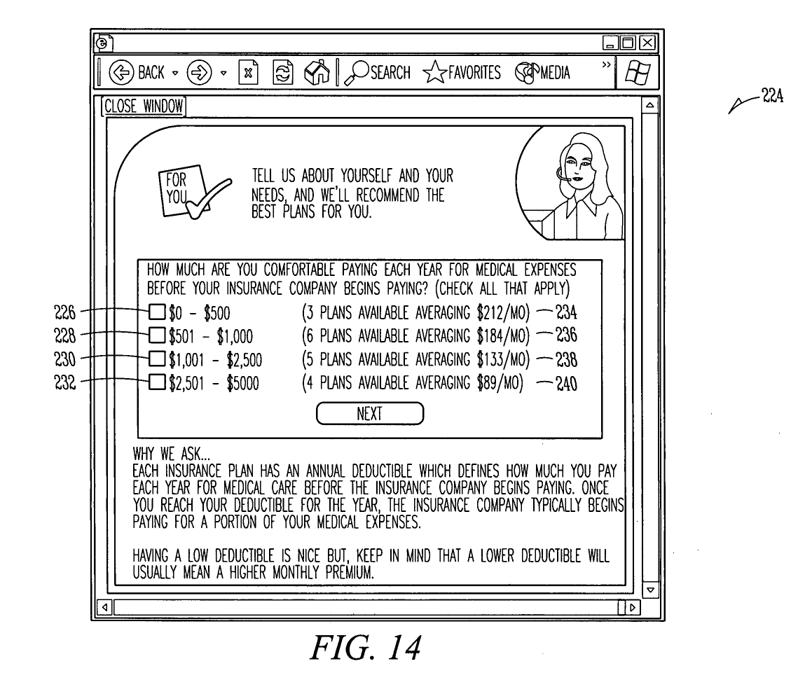

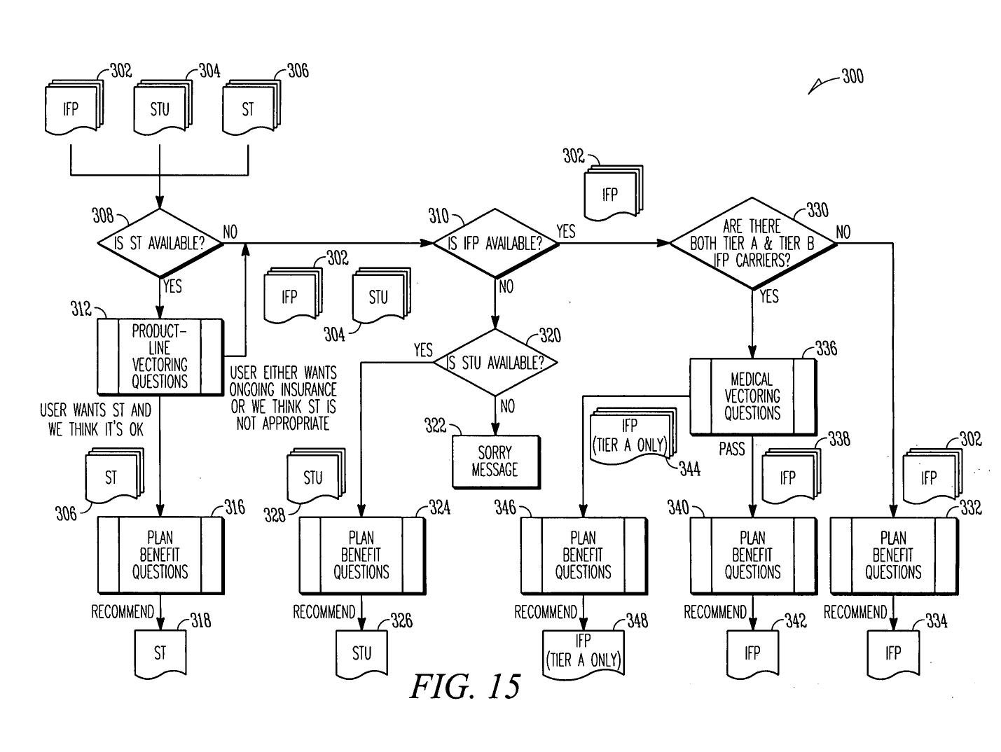

FIG. 15 shows a more detailed schematic flow diagram of a method 300, in accordance with an example embodiment, of recommending a limited number of health insurance plans to a user via the Internet. In the example shown, a total number of available health insurance plans includes a plurality of individual and family plans (IFP) 302, a plurality of student plans (STU) 304, and a plurality of Short-Term (ST) insurance plans 306. As shown at decision block 308, a determination may be initially made if a Short-Term plan is available and, if not, the method 300 may proceed to decision block 310. If, however, a Short-Term insurance plan is available, the method 300 may then proceed to block 312 where a plurality of product line vectoring questions are presented to the user. As mentioned above, the product line vectoring questions may be interactive and dynamic and subsequent or further questions presented to the user or applicant may depend on an answer to a previous question. The answers provided to the product line vectoring questions by the user may then be processed and, if it is determined that short-term insurance is not available based on the answers to the questions, the method 300 may once again proceed to decision block 310. It will be appreciated that the method 300 may proceed from block 312 to block 310 if a user wants ongoing insurance as opposed to short-term insurance, or that, based on the interaction with the user, it is determined that short-term insurance is not appropriate. If, however, the user requires short-term insurance and the recommendation tool 20, based on the product line vectoring questions, determines that short-term insurance is appropriate, the method 300 may then narrow down the total number of short-term plans 306. For example, as shown at block 316, the method 300 may present plan benefit questions to the user in an interactive and dynamic fashion identify relevant short-term plans. Based on the user interaction, the method 300 may then recommend one or more short-term insurance plans as shown at block 318. An example of a graphical user interface recommending insurance plans is shown in FIG. 14.

Returning to decision block 310, if none of the IFP plans 302 is available to the user, the method 300 then proceeds to decision block 320 to ascertain if any of the student plans 304 are available to the user. If none of the student plans is available to the user, a message is then presented to the user to indicate that no insurance plan is available and/or no insurance plan meets his or her needs (see block 322). If, however, there are one or more available student plans 328, a plan benefit questions module 324 may present a plurality of questions to the user to identify a limited number of appropriate student plans 326 to the user as shown at block 326. Thus, the plan benefit questions may reduce a number of available student plans 328 to a limited number of more appropriate student plans 326.

Returning to decision block 310, if one or more of the IFP plans 302 are available, then the method 300 proceeds to decision block 330. As described in more detail below, the available IFP plans 302 may be arranged or divided into two or more groups or tiers. For example, a Tier A group may be provided and a Tier B group may be provided wherein each group is associated with a likelihood of approval of the user for health insurance based on medical vectoring questions. If either Tier A or Tier B carriers are not available to the user, the method 300 may then proceed to block 332 where plan benefit questions are communicated to the user to identify more appropriate health insurance plans from the total number of possible IFP plans 302. Thus, after the total number of possible IFP plans 302 have been filtered or reduced down to a limited number, the limited number of IFP plans 334 are then recommended to the user. Returning to decision block 330, if both Tier A and Tier B IFP carriers are available to the user, medical vectoring questions are then posed to the user (see block 336) to identify a reduced number of IFP plans 338 from the total number of possible IFP plans 302. In order to reduce the number of possible IFP plans even further, plan benefit questions 340 are then presented to the user to identify a limited number of recommended IFP plans 342 which are then presented to the user. Circumstances may arise where, based on the medical vectoring questions (see block 336), only Tier A IFP plans 344 are appropriate to the specific user. For example, it may be determined that there is a reasonable likelihood that carriers of the Tier A IFP plans 344 will approve an application by the user and, accordingly, only those IFP plans that are likely to be approved are then presented to the user. In order to identify which of the IFP Tier A plans 344 are most appropriate for the user, plan benefit questions (see block 346) may be presented to the user and, as a result thereof, a limited number of recommended IFP plans 348 may then be presented to the user.

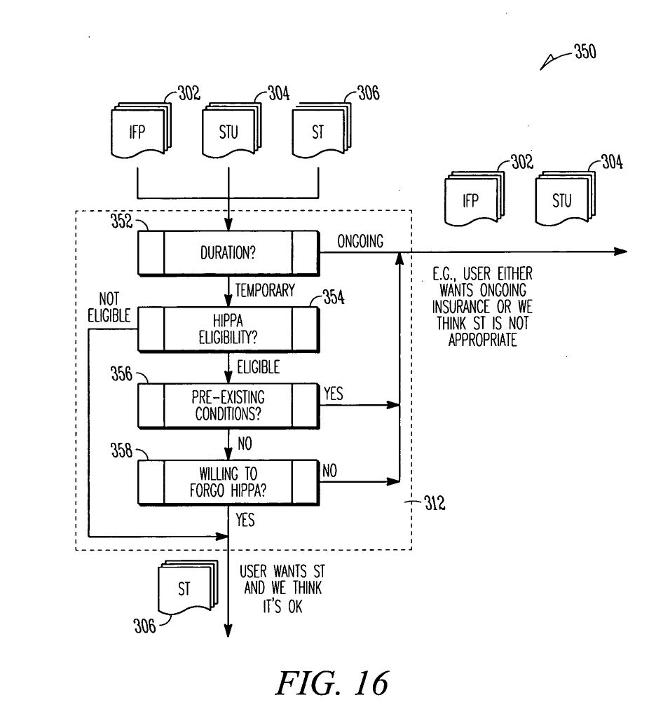

FIG. 16 shows a schematic flow diagram of a method 350, in accordance with an example embodiment, to present product line vectoring questions to a user. The method 350 may be performed at block 312 in the method 300 shown in FIG. 15 and, accordingly, is described by way of example with reference thereto. As shown at block 352, questions may be presented to the user to identify a duration of the health insurance plan required by the user. If, for example, the user selects an ongoing health insurance plan or the recommendation tool 20 considers short-term insurance not appropriate, the method 350 provides data on the total number of IFP plans 302 and the total number of student plans 304 to decision block 310 in FIG. 15. If, however, the user requires temporary or short-term insurance, as shown at block 354, the method 350 checks to see whether or not the user is eligible for protection under the Health Insurance Portability and Accountability Act of 1996 (HIPPA). If the user is eligible for HIPPA, then as shown at block 356 the method 350 determines whether any pre-existing conditions exist. If pre-existing conditions do exist, then as in the case of insurance of an ongoing nature, the method 350 proceeds to decision block 310 in FIG. 15. If, however, pre-existing conditions do not exist, then a determination is made as to whether or not the user is willing to forego the provisions of HIPPA (see block 358). If the user is not willing to forego the provisions of HIPPA then the method proceeds to decision block 310 in FIG. 15. If, however, the user is willing to forego the provisions of HIPPA and the user still wants short-term insurance and the recommendation tool 20 ascertains that such term insurance is appropriate, the method 350 proceeds to present plan benefit questions to the user (see block 316 in FIG. 15).

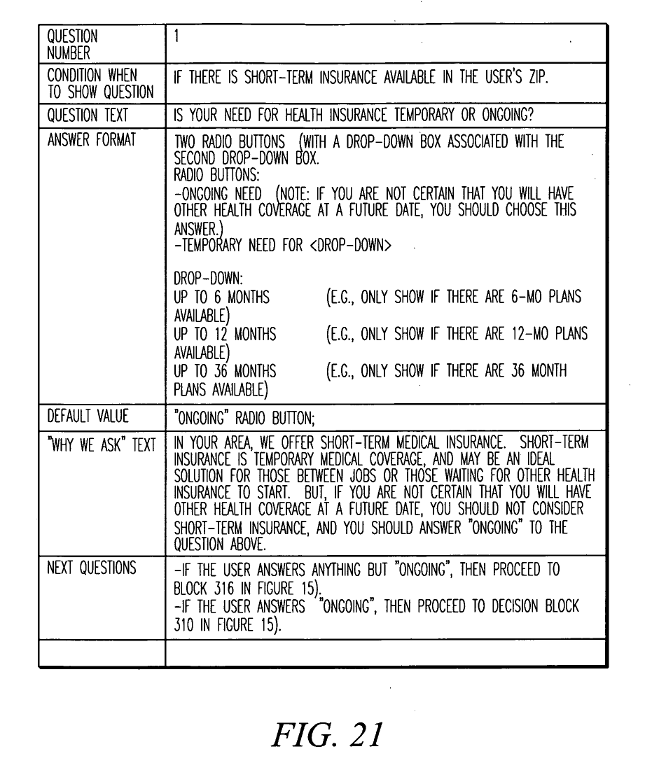

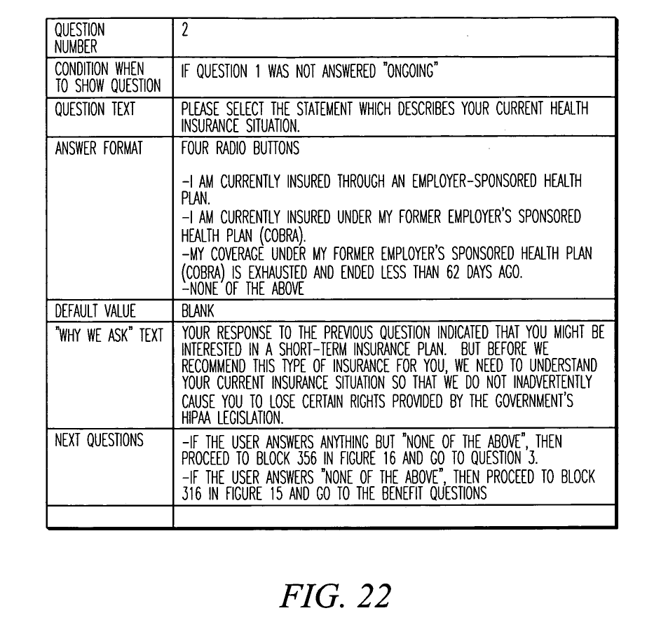

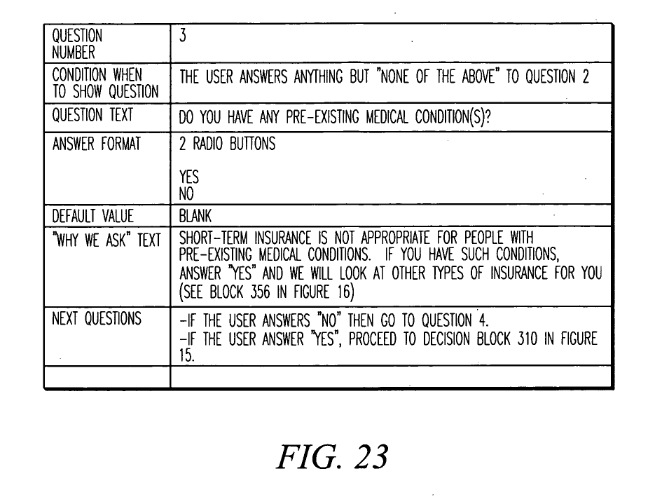

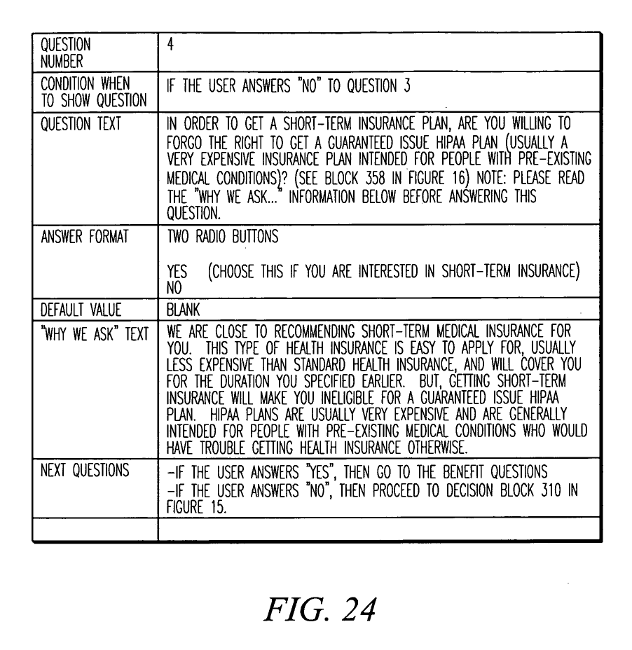

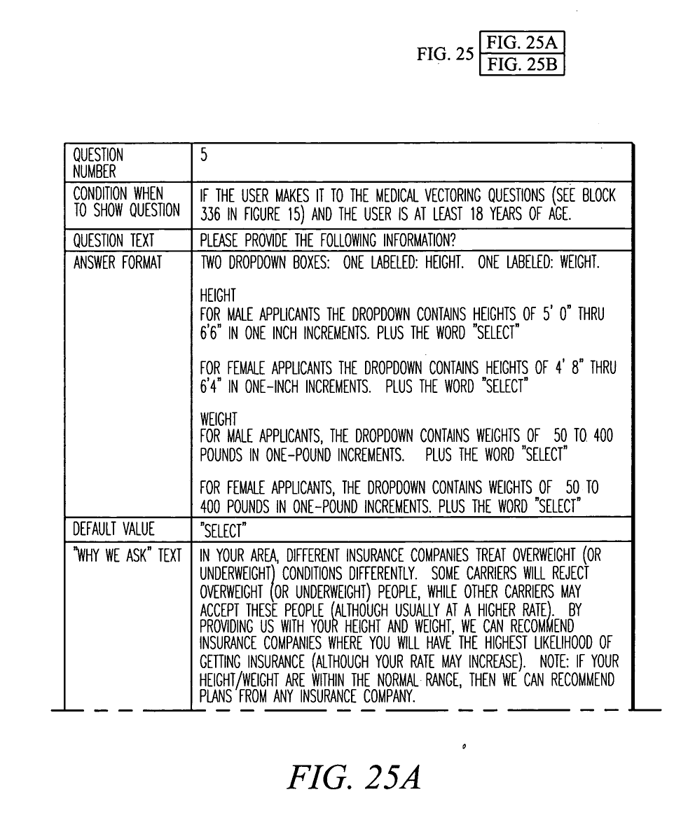

In an example embodiment, four product vectoring questions may be used to determine if a person should get Short-Term insurance or “Permanent” insurance (e.g. IFP or Student). Examples of such questions are shown in FIGS. 21-24.

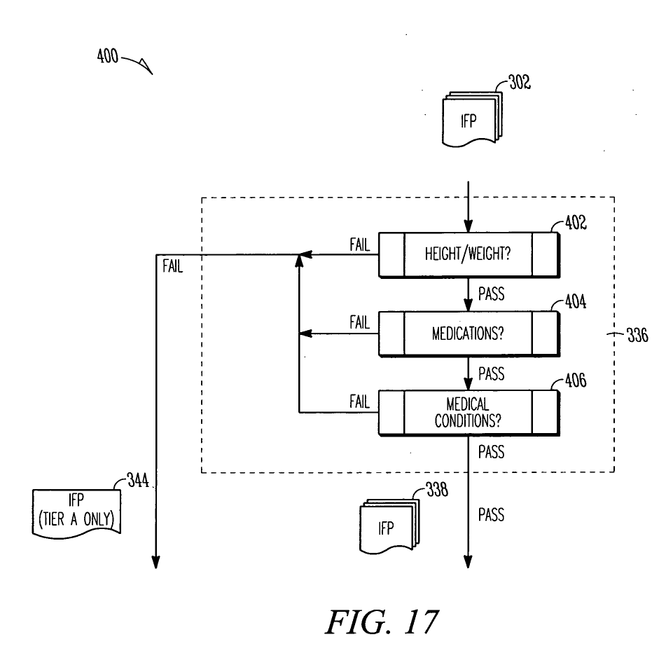

FIG. 17 shows a schematic flow diagram of a method 400, in accordance with an example embodiment, of presenting medical vectoring questions to a user. The method 400 may be performed at block 336 in the method 300 shown in FIG. 15 and, accordingly, is described by way of example with reference thereto. As shown at block 402, the method 400 first obtains height and weight information from the user and, if the user passes the height and weight preconditions, the method 400 may then present medication questions to the user as shown at block 404. If the user passes the medication questions, then questions relating to medical conditions (see block 406) are presented to the user. If the user passes all the questions in blocks 402-406, the method 400 may then proceed to present the user with plan benefit questions (see block 340 in FIG. 15) based on both Tier A and Tier B plans. If, however, the user fails any one of the height and weight questions, the medication questions, and the medical conditions questions, then the method 400 may proceed to present plan benefit questions (see block 346 in FIG. 15) that are related or associated only with IFP Tier A plans.

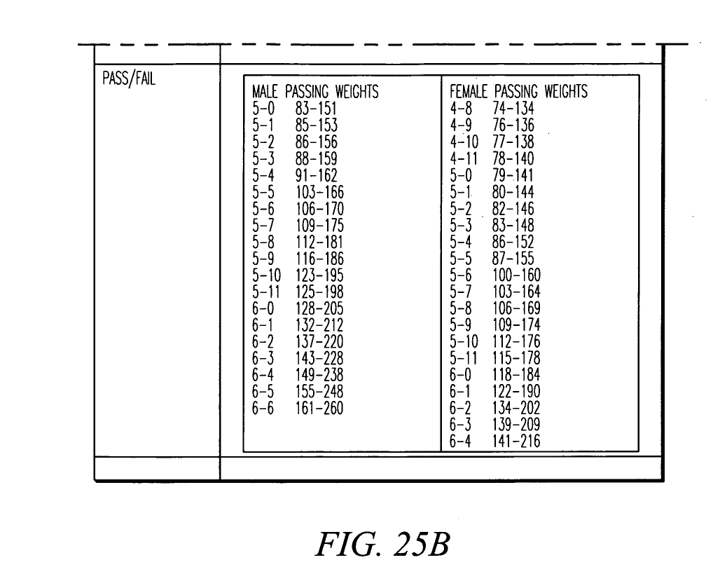

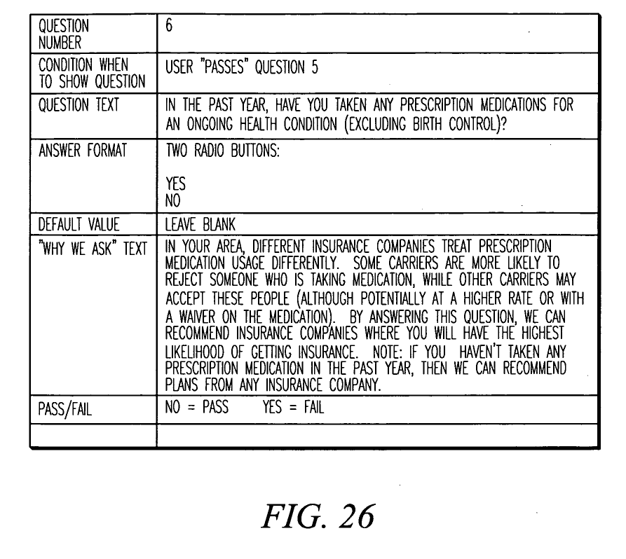

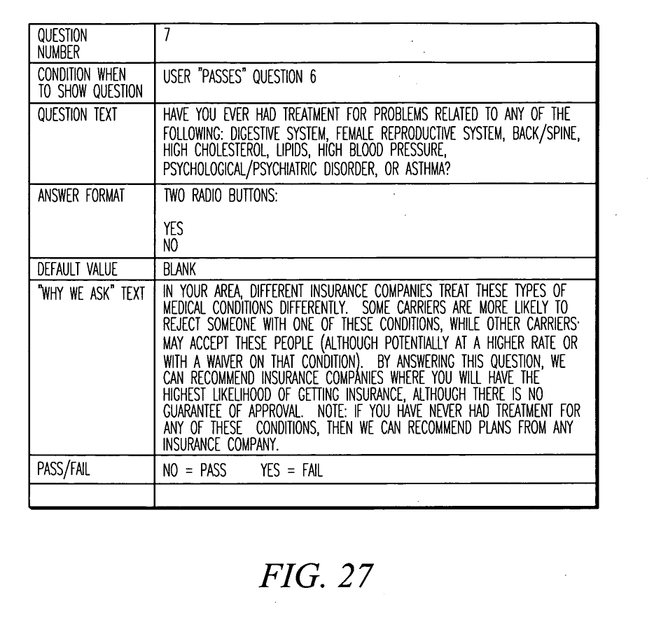

FIGS. 25-27 show example medical vectoring questions. In an example embodiment, the medical vectoring questions may be used to determine if the user should be directed to plans from carriers where they are more likely to get coverage. As discussed by way of example above, within each state (geographical region) carriers or health insurance providers mat be classified as either Tier A or Tier B providers. Tier A carriers may be those carriers who a Sales and Enrollment team considered to perform relatively well in terms of providing coverage for users or applicants who fail one of the medical questions. Tier B carriers may be those carriers who the Sales and Enrollment team consider to perform relatively poorly in terms of providing coverage for users or applicants who fail one of the medical questions.

In the example embodiment shown, each of the medical vectoring questions (see FIG. 25-27) may have a Pass/Fail condition. As soon as the user “fails” one of the three questions (see blocks 402-406), the rest of the Medical questions are not presented to the user. In an embodiment, recommendation tool 20 records the user's answers to questions and/or recommendation tool responses based on the answers, For example, the recommendation tool 20 may record “Pass” or “Fail” for future reference and use. In an embodiment, a work queue rule may be created that gives a lower priority to users (or applications) that have “failed” the medical questions.

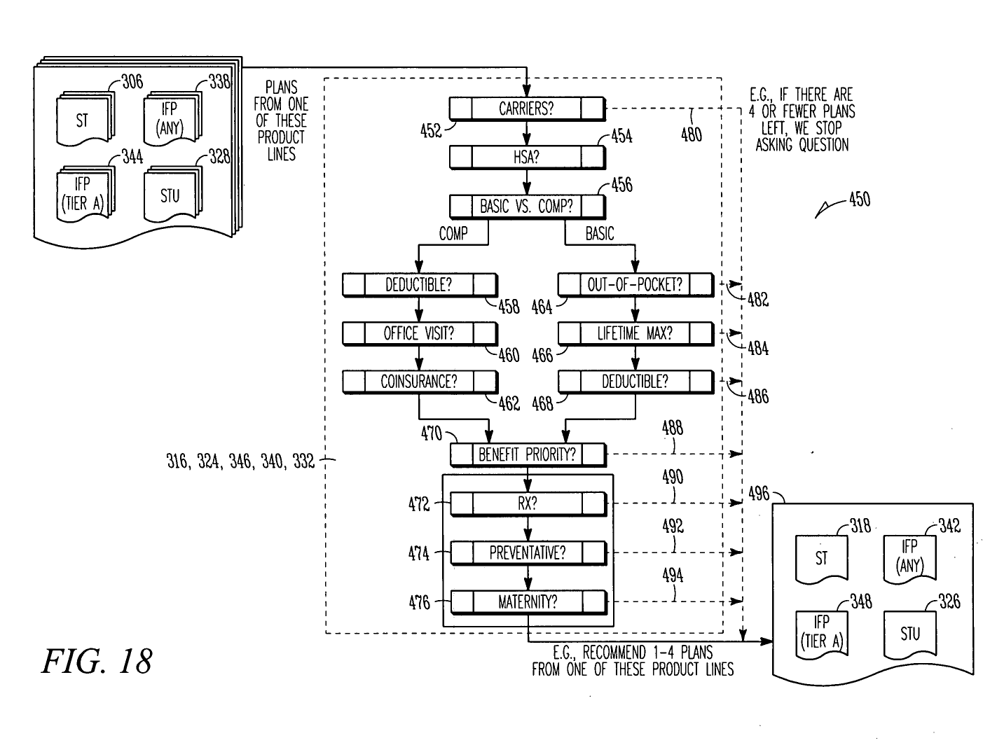

FIG. 18 shows a schematic flow diagram of a method 450, in accordance with an example embodiment, of presenting plan benefit questions to a user. The method 450 may be performed at any of the blocks 316, 324, 346, 340 and 332 of the method 300 in FIG. 15 and, accordingly, the method 450 is described by way of example with reference thereto.

As described above, based on user interaction, a smaller number of more relevant health insurance plans may be identified from a total pool of plans. For example, a reduced number short-term plans 306, reduced number of IFP plans 338, a reduced number of Tier A IFP plans 344, and student plans 328 may be identified. These plans may then be processed by the method 450. In particular,, as shown at block 352, a determination is made to see how many health insurance carriers are available offering a reduced number of short-term plans 306, reduced number of IFP plans 338, a reduced number of Tier A IFP plans 344, and student plans 328. In an example embodiment, if there are four or fewer plans left, the questions presented to the user may be terminated and the method 450 proceeds to recommend the plans to the user as shown at 496. If, however, there are more than a predetermined number of plans left (e.g. more than four plans) then a determination is made at block 454 to see if a health savings account (HSA) is requested by the user. A HSA plan may be administered through a company and may rollover each year. Unlike a flex plan, an HSA plan may earn interest. A health savings account may however require a high deductible.

A determination is then made at block 456 whether basic coverage or comprehensive coverage is required. For example, the user may only require or seek health insurance in the event of a major accident or an illness such as cancer and, in these circumstances, may require only basic coverage. Thus, the user may only require a health insurance plan for “catastrophic” events. However, a user (or family member) who frequently visits a doctor may instead require more comprehensive coverage. If a user selects comprehensive coverage then the user is first presented with a question relating to a deductible(see block 458), thereafter a question is presented to determine if office visits will be required (see block 460), and then with a question to determine whether or not coinsurance is required (see block 462). If, however, the user requires or seeks basic coverage, the user is first provided a question to determine if out-of-pocket expenses are acceptable (see block 464) and, thereafter, a life time maximum insurance value required by the user (see block 466), and, finally, a question is presented to determine if the user wants a deductible (see block 468). It will be noted that when a user requests comprehensive insurance, the question relating to a deductible (see block 458) is first presented to the user whereas, when a user requires basic insurance only, the question relating to the deductible (468) is presented last to the user.

Following the questions relating to coinsurance (see block 462) and the questions relating to the deductible (see block 468), the method 450 then presents a sequence of questions to the user to identify benefit priorities (see block 470). For example, 20 health insurance plans may have been identified as being potentially relevant to the user and, by asking questions relating to a priority the user attaches to various benefits, the total number of plans remaining may be narrowed down to a few, more appropriate plans. Example questions include asking a user which benefits are more important to the user, which benefits the user would be more likely to pay an additional premium for, and the like. Thereafter, as shown at block 472 RX (e.g., prescription drug benefits) coverage questions are presented to the user, at block 474 preventative measure questions are presented to the user, and, finally, at block 476 maternity questions are presented to the user. Based on the answers by the user, a limited number of health insurance plans are then presented to the user as shown at 496. If there are less than a predetermined or pre-selected number of plans remaining (e.g. if there are four or fewer plans remaining), it may no longer be necessary to present further questions to the user and the method 450, as shown by lines 480-494, may proceed directly and present the recommended plans to the user (as shown at 496).

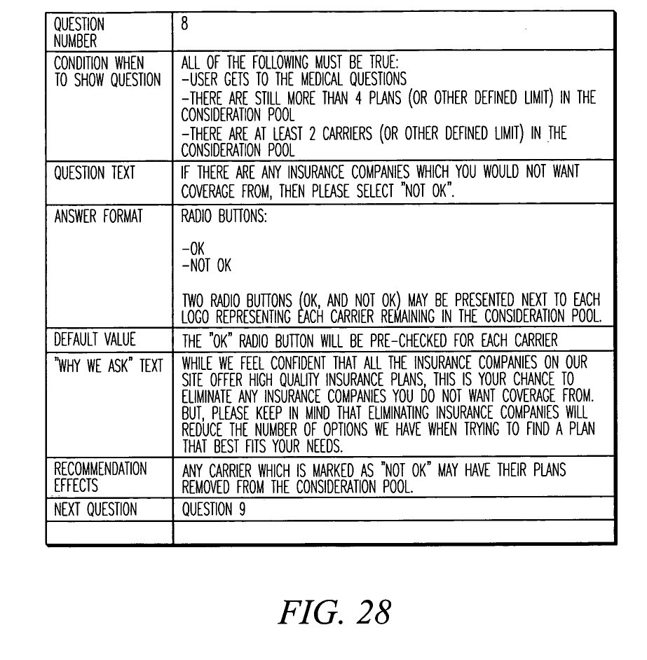

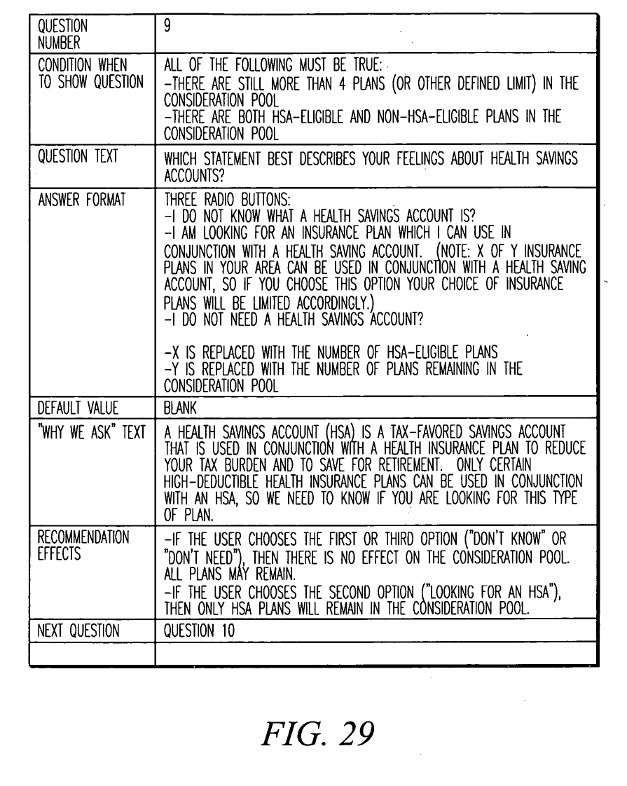

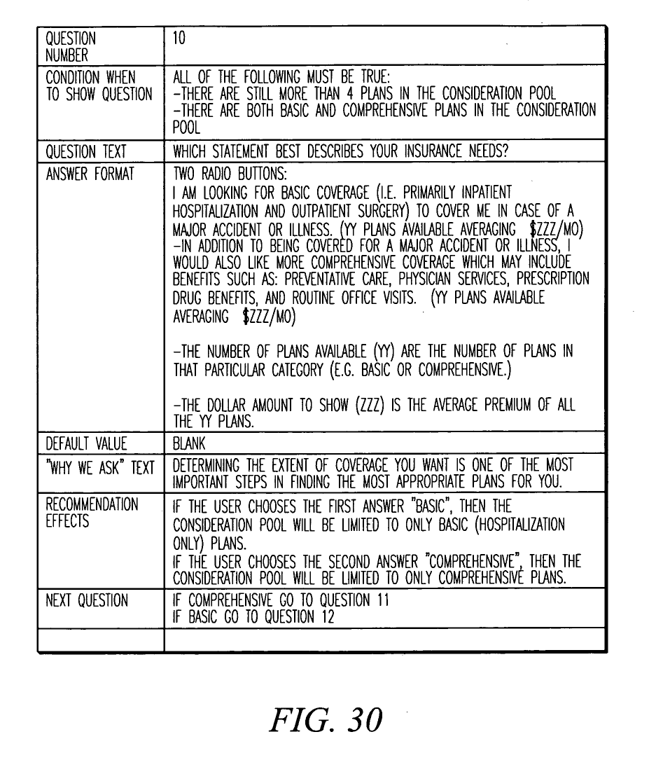

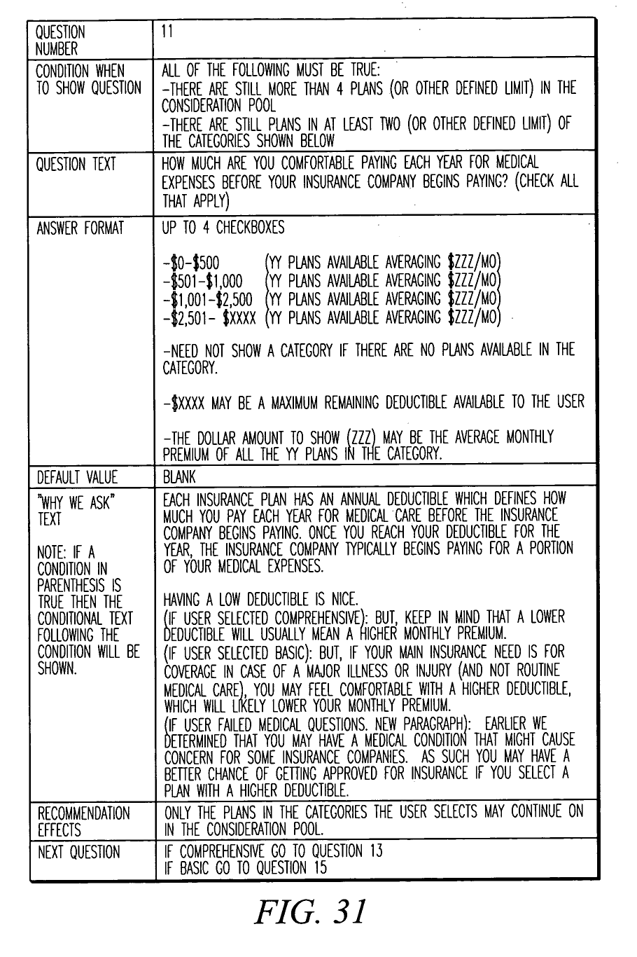

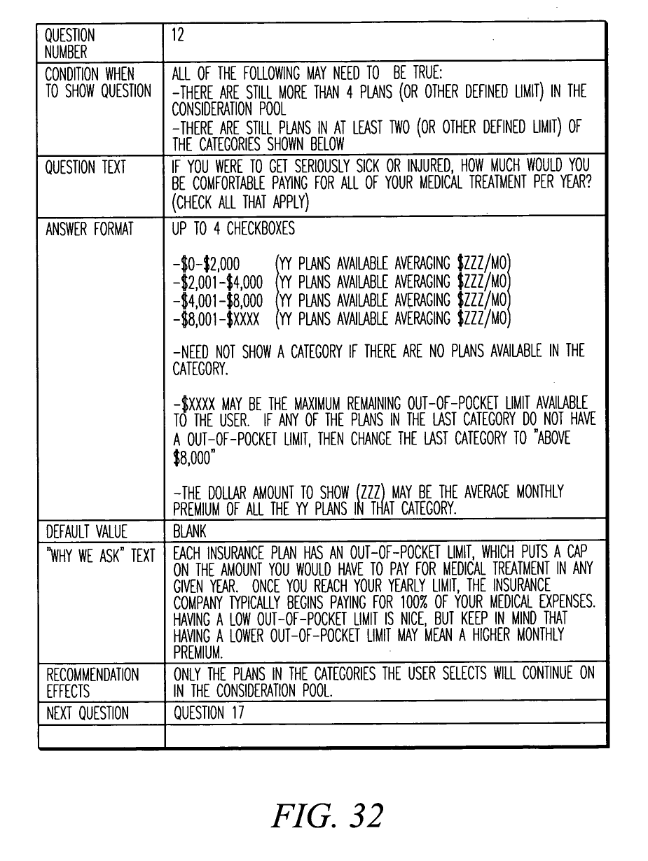

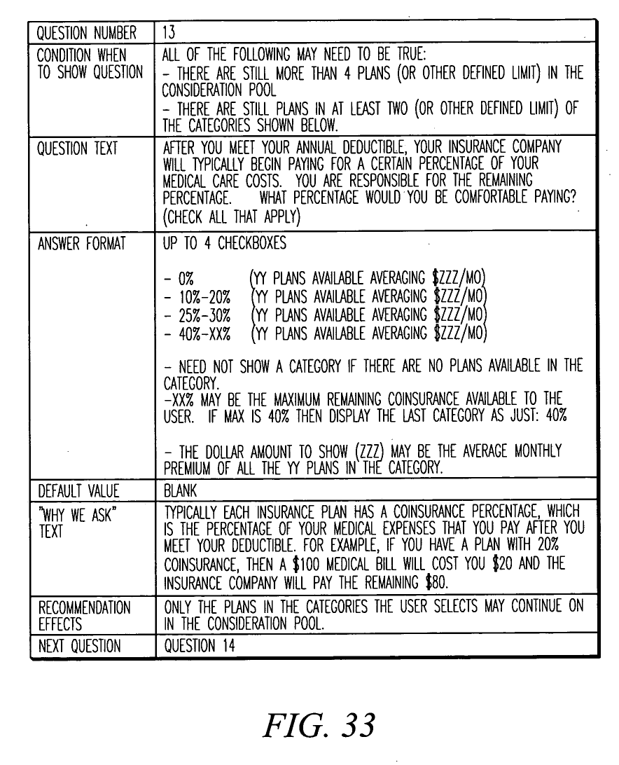

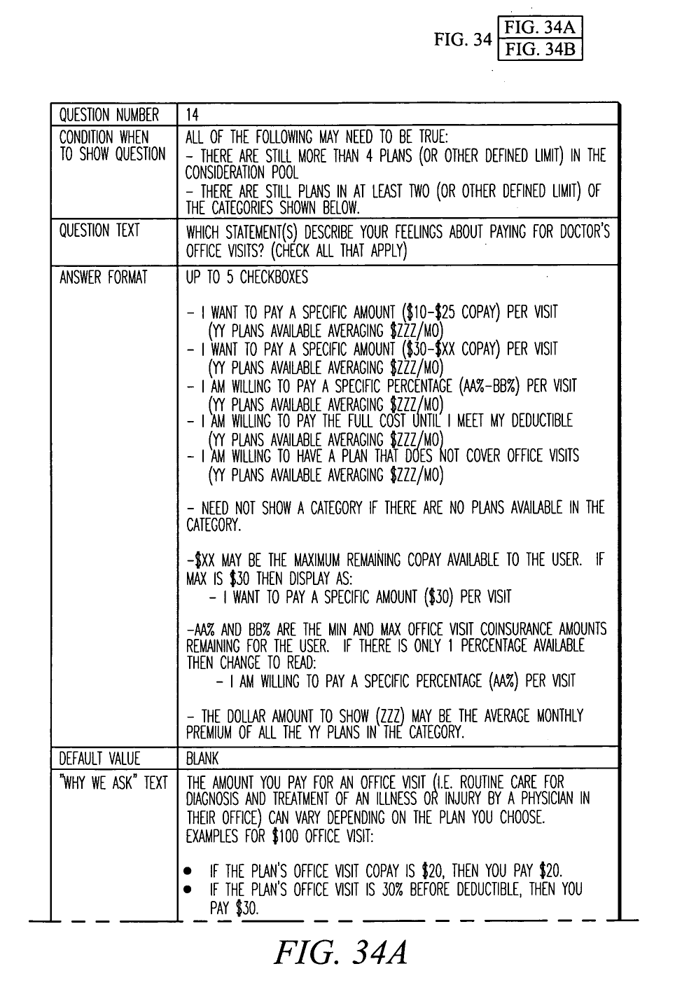

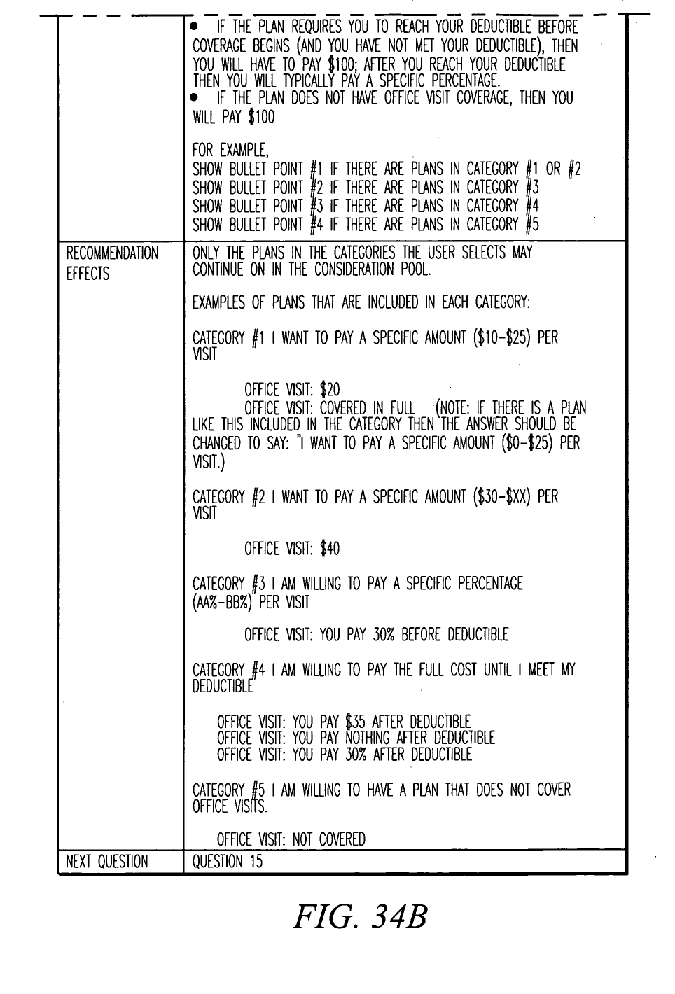

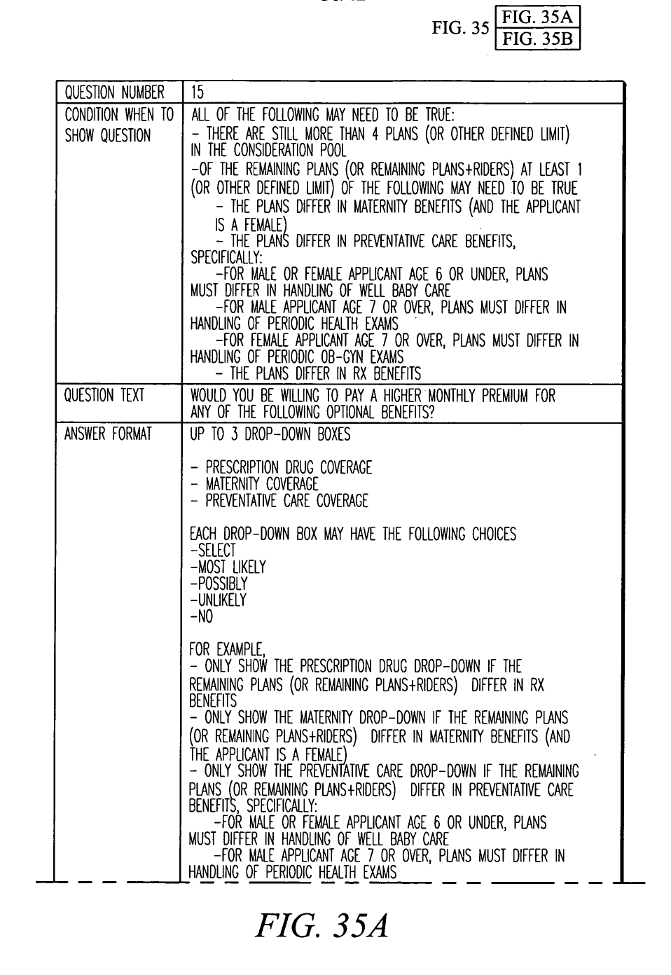

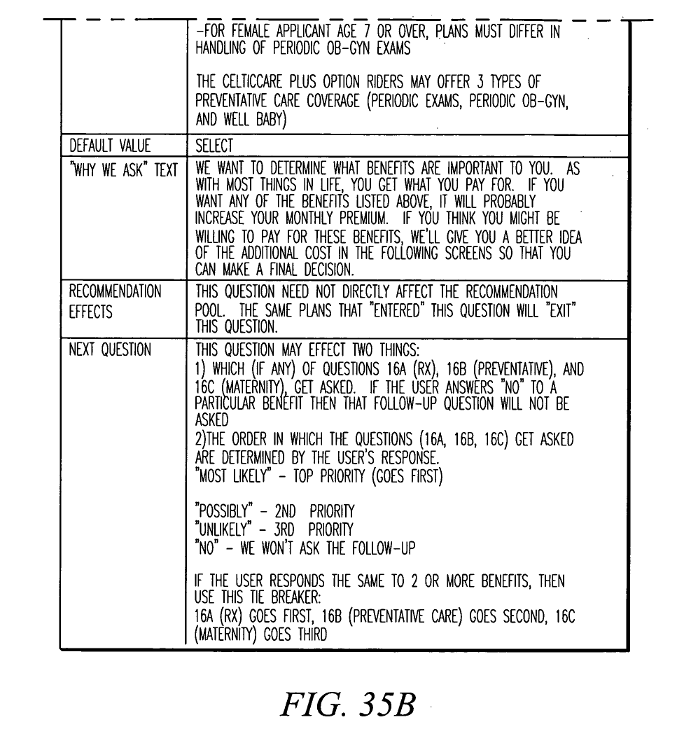

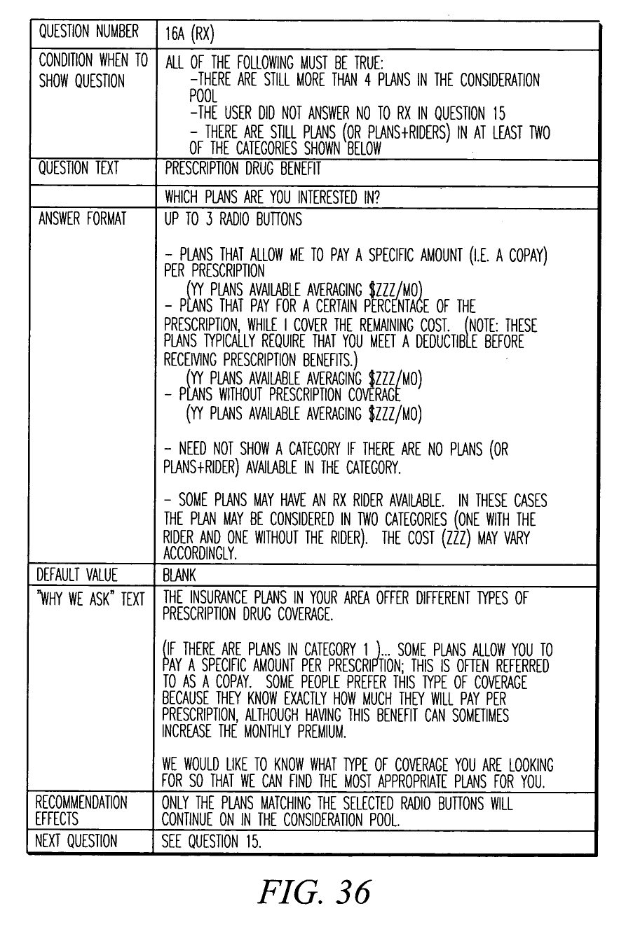

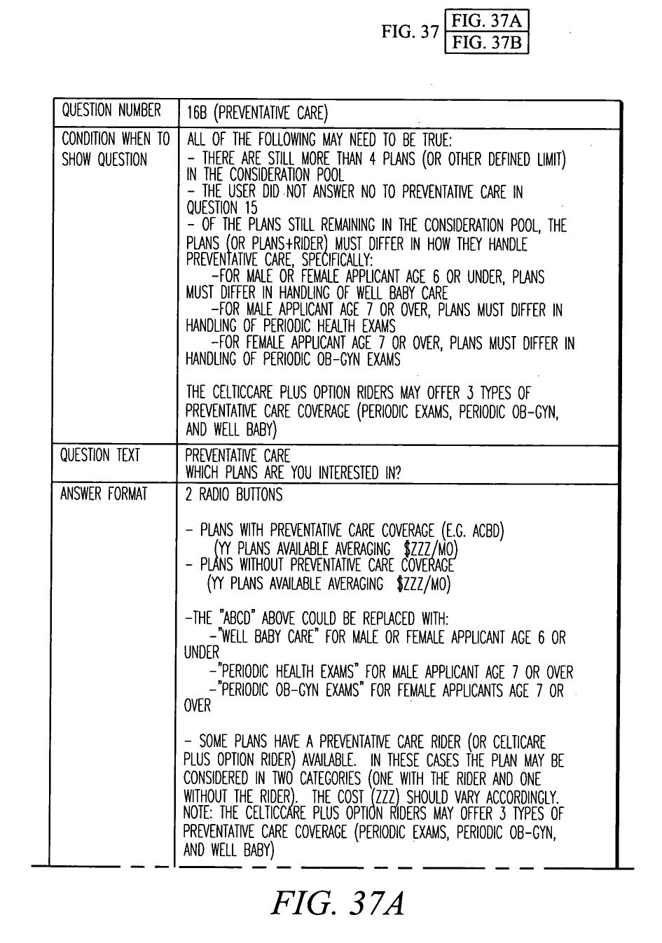

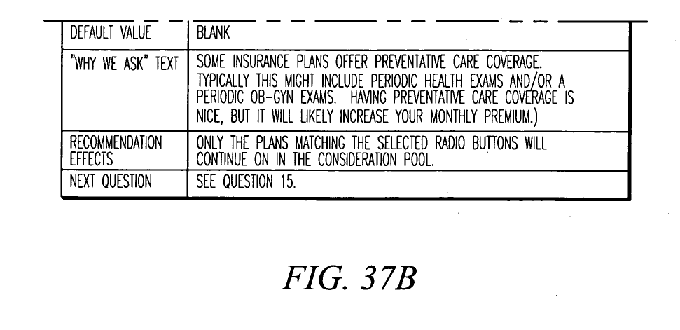

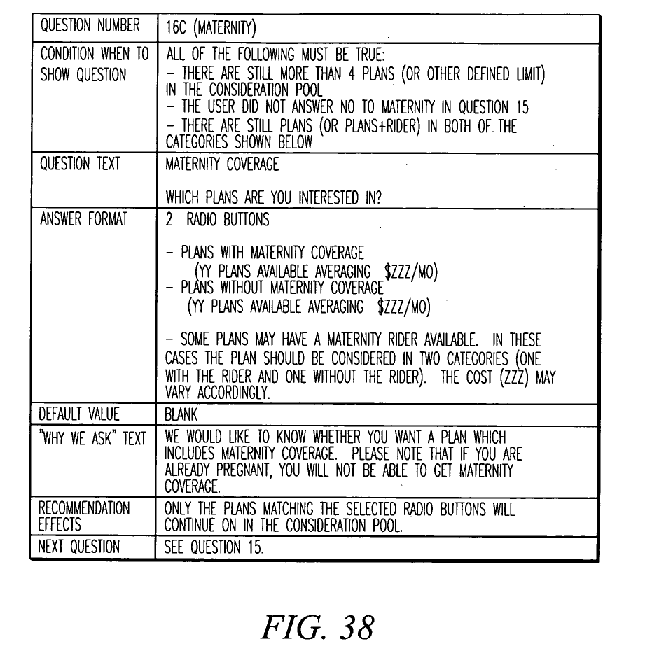

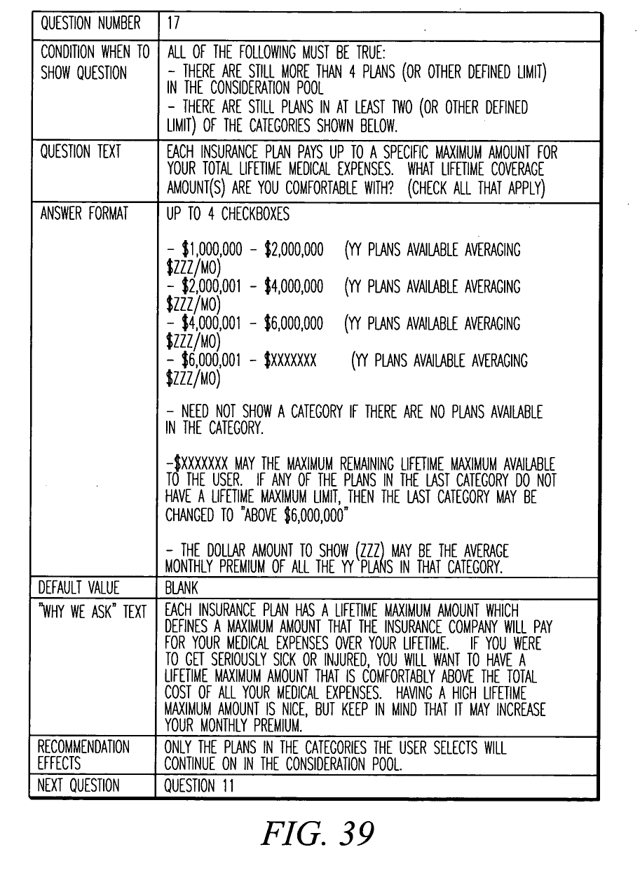

FIGS. 28-39 show example plan benefit questions presented to the user or applicant. The benefit questions may determine what types of benefits are important to the user. In the example method 300 shown in FIG. 15, by the time the user gets to the plan benefit questions, it is known what health insurance plans are still under consideration for and eligible for recommendation. These health insurance plans may be referred to as a consideration pool. For example, for IFP plans, the consideration pool may comprise IFP plans 338 from any carrier (whether Tier-A or Tier B) or just from Tier-A carriers 344 (see FIG. 15).

In an embodiment, if at the end of the plan benefit questions there are still more than four plans (or any other chosen limit of plans) in the Consideration Pool, then “Tiebreaker” rules may be used to further limit the number of health insurance plans. For example, one or more of the following rules may be used:
If there are 4 carriers in the Consideration Pool, then the lowest priced plan from each of the 4 carriers may be recommended.
If there are 3 carriers in the Consideration Pool, then the lowest priced plan from each of the 3 carriers, plus the next lowest priced plan from any carrier may be recommended.
If there are 2 carriers in the Consideration Pool, then the lowest priced plan from each of the 2 carriers, plus the next 2 lowest priced plans from any carrier may be recommended.
If there is 1 carrier in the recommendation pool then the 4 lowest priced plans may be recommended.
If there are 5 or more carriers in the Consideration Pool, then the lowest priced plan from the four lowest priced carriers may be recommended.

In an embodiment, the recommendation tool 20 allows the user to specify or select whether or not they want certain coverage (e.g. Maternity, Prescription Drugs, Preventative Care, or the like). In these circumstances, the recommendation tool 20 may identify plans that may either have the coverage built into the plan, or the coverage provided through one or more optional riders. Thus, it will be appreciated that a “Quote” page in this embodiment may be modified to take the selected coverage into account. Premium amounts that are displayed may then take such riders into account (e.g., the premium shown may include the base plan plus the riders). The user may be requested to make sure that all desired optional coverage is selected during the application process.

In an example embodiment, “Why” links may be provided for one or more health insurance plans to explain why that particular plan was recommended. In an embodiment, where the user is requesting detail of or applying for multiple parties (e.g., a spouse and children), the recommendation tool may provide more recommendations (e.g., more than four recommended health insurance plans). Access to the recommendation tool button 121 may be provided on any web page in a web deployment of the recommendation tool (e.g. at “Home” page, Zip Page, or any other page). In an embodiment, after the user has been on the Quote page 119 (see FIG. 9) for a certain period of time, a recommendation tool pop-up window may be automatically generated and the user may be asked if they would like help finding a plan. In an embodiment, the recommendation tool 20 may provide recommendations even if the user does not finish answering all the questions, include carrier-specific eligibility questions, provide specific Height/Weight charts by carrier, provide more decision criteria (e.g., plan type, ease of application process, when coverage needed), recommend plans that have the user's doctor included in the Network (e.g., using a unified physician directory), or the like.

In an example embodiment, a “Progress Bar” is provided to indicate to the user or applicant how far along the recommendation process the user has progressed. Users may be provided with a “Save” button to save their answers, so that when they return later, they don't have to go through the whole process from start.

Thus, in an example embodiment, the recommendation tool 20 may vector or direct the user to one or more of the most appropriate products (e.g., IFP, Short-Term, or Student insurance). In order to accomplish this, in an example embodiment, questions that are sequentially asked may be broken down into 3 categories. Product vectoring questions may vector or direct a customer to a specific product line (e.g. “How long do you need coverage for?”). Medical vectoring questions may accommodate the fact that different carriers may treat certain medical conditions differently. If the customer does not pass all the medical vectoring questions, the recommendation tool 20 may attempt to route the user to health insurance carriers where they are more likely to get approved. Benefit questions may identify what benefits are important to the user (e.g. Deductible, Rx, Office Visit Copay, etc.).

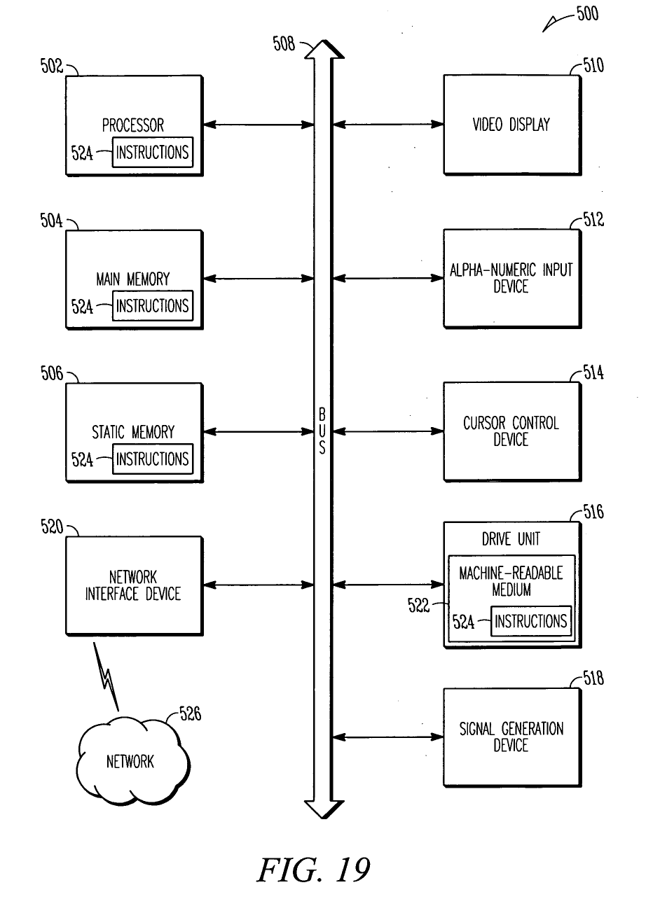

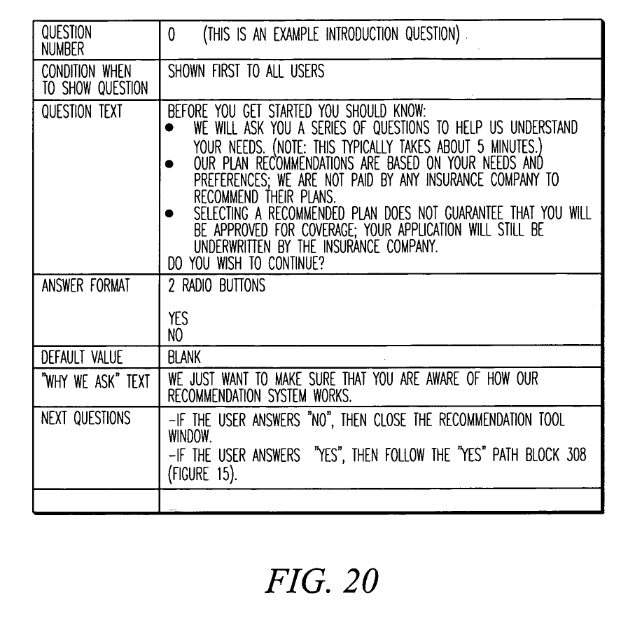

FIG. 19 shows a diagrammatic representation of machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to comprise any collection of machines that individually or jointly execute a set (or multiple sets) of instructions to perform any one or more of the methodologies discussed herein.

The example computer system 500 comprises a processor 502 (e.g., a central processing unit (CPU) a graphics processing unit (GPU) or both), a main memory 504 and a static memory 506, which communicate with each other via a bus 508. The computer system 500 may further comprise a video display unit 510 (e.g., a liquid crystal display (LCD) or a cathode ray tube (CRT)). The computer system 500 also comprises an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 comprises a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to comprise a single medium or multiple media (e.g., a centralized or distributed database, and/or associated caches and servers) that store the one or more sets of instructions. The term “machine-readable medium” shall also be taken to comprise any medium that is capable of storing, encoding or carrying a set of instructions for execution by the machine and that cause the machine to perform any one or more of the methodologies of the present invention. The term “machine-readable medium” shall accordingly be taken to comprise, but not be limited to, solid-state memories, optical and magnetic media, and carrier wave signals.

Although the networked-based system 10 is described, by way of example, with reference to health insurance plans it will be appreciated to a person of skill in the art that it is not limited to health insurance plans or any other types of insurance plans.

Thus, a method and system to recommend at least one insurance plan have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of recommending at least one insurance plan to a user, the method including:
presenting at least one question to a user via a client device, the question being for identification of the at least one insurance plan;
receiving an answer to the question from the client device;
investigating a database to identify a subsequent question associated with the answer provided to the first question by the user, the subsequent question also being for identification of the at least one insurance plan;
presenting the subsequent question to the user; and
receiving a subsequent answer to the subsequent question, wherein the investigating the database to identify a subsequent question and receiving the subsequent answer is iteratively performed to identify the at least one insurance plan.

2. The method of claim 1, wherein the insurance plan is a health insurance plan.

3. The method of claim 1, which includes investigating the database to identify a subsequent question and receiving the subsequent answer is iteratively performed until a number of available insurance plans has been narrowed dawn to a preselected number of insurance plans.

4. The method of claim 1, which includes providing educational information associated with at the subsequent question.

5. The method of claim 1, wherein the subsequent question includes a product line vectoring question to identify at least one product line to recommend to the user.

6. The method of claim 5, wherein the product line vectoring question relates to only those product lines available to a specific user.

7. The method of claim 1, wherein the subsequent question includes a medical vectoring question to identify at least one insurance carrier to recommend to the user.

8. The method of claim 7, wherein the medical vectoring question relates to only an insurance plan available to a specific user.

9. The method of claim 1, wherein the subsequent question includes plan benefit questions to identify at least one insurance plan to recommend to the user.

10. The method of claim 9, wherein the plan benefit question relates only to those insurance plans being identified as a possible recommended plan.

11. The method of claim 1, wherein a plurality of subsequent questions are present to the user, the plurality of subsequent questions including a subset of product line vectoring questions to identify at least one product line to recommend to the user, followed by a subset of medical vectoring questions to identify at least one insurance carrier to recommend to the user, and followed by a subset of plan benefit questions to identify at least one insurance plan to recommend to the user.

12. The method of claim 1, wherein the insurance plans are health insurance plans selected from the group consisting of an Individual and Family insurance plan, a short-term insurance plan, a student health insurance plan, and a health care savings plan.

13. The method of claim 1, wherein the at least one question includes identifying a geographical location of the user to determine insurance plans available for the geographic location.

14. The method of claim 13, wherein at least one question is a request for a ZIP code to identify the geographical location.

15. The method of claim 1, wherein at least one question includes at least one question selected from the group including a ZIP code of the user, and date of birth of the user.

16. The method of claim 15, which includes:
determining if Short Term insurance is available to the user based on the answer to the at least one question, and
if Short Term insurance is available, the subsequent question relates to plan benefit questions associated with the Short Term insurance.

17. The method of claim 15, which includes:
determining if Individual and Family Plan (IFP) insurance is available to the user based on the answer to the at least one question, and if Individual and Family Plan (IFP) insurance is available, the subsequent questions are medical vectoring questions associated with Individual and Family Plan (IFP) insurance and relate to the user; and
identifying at least one insurance plan from the medical vectoring questions.

18. The method of claim 17, wherein the medical vectoring question includes height of the user, medication information, and medical conditions.

19. The method of claim 15, which includes:
determining if Individual and Family Plan (IFP) insurance is available to the user based on the answer to the at least one question; and
if Individual and Family Plan (IFP) insurance is not available, determining if Student Insurance is available to the user; and
if Student Insurance is available, communicating a subsequent question in the form of a plan benefit question relating to student health insurance plans to the user.

20. The method of claim 1, wherein the subsequent question is a product line vectoring question selected from the group including a duration of desired insurance coverage, if the user is eligible for coverage by Health Insurance Portability and Accountability Act (HIPPA), if a preexisting condition exists, and if the user is willing to forego the provisions of HIPPA.

21. The method of claim 1, wherein insurance carriers are divided into at least two tiers, each tier having subsequent questions associated with plan benefits.

22. The method of claim 1, wherein the subsequent question identifies at least one plan benefit including a Health Savings Account (HSA), comprehensive insurance coverage, and basic insurance coverage.

23. The method of claim 22, wherein when the answer to a subsequent question identifies that comprehensive insurance coverage is required, and wherein subsequent questions are sequentially communicated to identify if the user selects a deductible, an office visit payment and coinsurance payment.

24. The method of claim 22, wherein when the answer to a subsequent question identifies that basic insurance coverage is required, and wherein subsequent questions are sequentially communicated to identify if the user selects to pay out-of-pocket, a lifetime maximum and a deductible.

25. The method of claim 1, which includes:
determining a plurality of monetary ranges;
identifying a plurality of insurance plans in each monetary range; and
communicating a graphical user interface displaying the monetary ranges and the a number of insurance plans in each range.

26. The method of claim 25, which includes:
monitoring selection of one of the plurality of ranges by the user; and
communicating details of each plan within a selected range to the user.

27. A machine-readable medium embodying instructions which, when executed by a machine, cause the machine to perform the method of claim 1.

28. A system to recommend at least one insurance plan to a user, the system including:
a graphical user interface module to present at least one question to a user via a client device, the question being for identification of the at least one insurance plan;
a recommendation system to:
receive an answer to the question from the client device;
investigate a database to identify a subsequent question associated with the answer provided to the first question by the user, the subsequent question also being for identification of the at least one insurance plan;
present the subsequent question to the user; and
receive a subsequent answer to the subsequent question, wherein investigating the database to identify a subsequent question and receiving the subsequent answer is iteratively performed to identify at least one insurance plan.

29. A system to recommend at least one insurance plan to a user, the system including:
means for presenting at least one question to a user via a client device, the question being for identification of the at least one insurance plan;
means for receiving an answer to the question from the client device;
means for investigating a database to identify a subsequent question associated with the answer provided to the first question by the user, the subsequent question also being for identification of the at least one insurance plan;
means for presenting the subsequent question to the user; and
means for receiving a subsequent answer to the subsequent question, wherein the investigating the database to identify a subsequent question and receiving the subsequent answer is iteratively performed to identify the at least one insurance plan.
